(19) United States
(12) Patent Application Publication
(10) Pub. No.: US 2016/0361674 A1
(43) Pub. Date: Dec. 15, 2016

(54) FILTER MEDIA INCLUDING FINE STAPLE FIBERS

(71) Applicant: Hollingsworth & Vose Company, East Walpole, MA (US)

(72) Inventors: Sneha Swaminathan, Merrimack, NH (US); Svetlana Krupnikov, Ashland, MA (US)

(73) Assignee: Hollingsworth & Vose Company, East Walpole, MA (US)

(21) Appl. No.: 15/178,199

(22) Filed: Jun. 9, 2016

Related U.S. Application Data
(63) Continuation-in-part of application No. 14/569,909, filed on Dec. 15, 2014.

(51) Int. Cl. B01D 39/04; B01D 39/16

(52) U.S. Cl. CPC B01D 39/04; B01D 39/1623; B01D 2239/0208; B01D 2239/0414; B01D 2239/0618; B01D 2239/0636; B01D 2239/0654; B01D 2239/0622; B01D 2239/0478

(57) ABSTRACT

Filter media comprising fine staple fibers and related components, systems, and methods associated therewith are provided. In some embodiments, a filter media may include a layer (e.g., a wet laid layer) comprising polymeric staple fibers having a relatively small average diameter (e.g., less than or equal to about 1 micron). The polymeric staple fiber layer may be designed to impart desirable properties to the filter media, such as a high particulate efficiency and/or fluid separation efficiency, while having relatively minimal or no adverse effects on one or more properties of the filter media that are important for a given application. The filter media, described herein, may be particularly well-suited for a variety of applications.

### RELATED APPLICATIONS

This application is a continuation-in-part of U.S. application Ser. No. 14/569,909, filed Dec. 15, 2014, and entitled “Filter Media Including Fine Staple Fibers”, which is incorporated herein by reference in its entirety.

### FIELD OF INVENTION

The present embodiments relate generally to filter media comprising fine staple fibers which may be used in a variety of applications (e.g., fuel applications) and, specifically, to filter media comprising fine staple fibers having enhanced performance characteristics.

### BACKGROUND

Filter elements can be used to remove contamination in a variety of applications. Such elements can include a filter media which may be formed of a web of fibers. The fiber web provides a porous structure that permits fluid (e.g., gas, liquid) to flow through the media. Contaminant particles (e.g., dust particles, soot particles) contained within the fluid may be trapped on or in the fiber web. Depending on the application, the filter media may be designed to have different performance characteristics such as enhanced fluid separation efficiency, e.g., fuel/water separation efficiency, and/or enhanced particulate separation efficiency.

In some applications, filter media may include one or more layers comprising synthetic fibers. Although filter media comprising synthetic fibers exist, improvements in the performance characteristics of the layers within the media (e.g., efficiency) would be beneficial.

### SUMMARY OF THE INVENTION

Filter media comprising fine staple fibers and related components, systems, and methods associated therewith are provided. The subject matter of this application involves, in some cases, interrelated products, alternative solutions to a particular problem, and/or a plurality of different uses of structures and compositions.

In one set of embodiments, a series of filter media are provided. In some embodiments, a filter media comprises a first layer comprising a first plurality of polymeric staple fibers having an average fiber diameter of less than or equal to about 3 microns and an average length of less than or equal to about 10 cm. The filter media also includes a second layer comprising fibers having an average fiber diameter of greater than or equal to about 4 microns, and a third layer, wherein the third layer is a non-wetlaid layer. At least one surface of the first, second, and third layers is surface modified. The filter media also has an air permeability between 0.3 CFM and 300 CFM and a basis weight of between 5 g/m² and 1,000 g/m².

In another embodiment, a filter media comprises a surface modified layer comprising a first plurality of polymeric staple fibers having an average fiber diameter of less than or equal to about 1 micron and an average length of less than or equal to about 10 cm, wherein the thickness of the first layer is less than or equal to about 0.2 mm. The filter media also includes a second layer comprising fibers having an average fiber diameter of greater than or equal to about 4 microns, wherein the filter media has a dry Mullen burst strength between 0.5 psi and 200 psi.

In another embodiment, a filter media comprises a surface modified layer comprising a first plurality of polymeric staple fibers having an average diameter of less than or equal to about 1 micron and a second plurality of polymeric staple fibers having an average diameter of less than or equal to 1 micron, wherein the first layer has a water contact angle between about 30 degrees and 165 degrees. The filter media also includes a second layer comprising fibers having an average diameter of greater than or equal to about 4 microns, wherein the filter media has an air permeability between 0.3 CFM and 300 CFM and a basis weight of between 5 g/m² and 1,000 g/m².

In another embodiment, a filter media comprises a first layer comprising first plurality of polymeric staple fibers having an average fiber diameter of less than or equal to about 1 micron and an average length of less than or equal to about 10 cm. The filter media also includes a second non-wet laid layer comprising fibers having an average fiber diameter of greater than or equal to about 4 microns and a mesh layer.

Filter elements including one or more of the filter media described above and herein are also provided.

Methods of filter fluids using one or more of the filter media and/or filter elements described above and herein are also provided.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram showing a cross-section of a filter media including a layer comprising fine staple fibers according to one set of embodiments;

FIG. 2A is a schematic diagram showing a cross-section of a filter media including multiple layers according to one set of embodiments;

FIG. 2B is a schematic diagram showing a cross-section of another filter media including multiple layers according to one set of embodiments;

FIG. 2C is a schematic diagram showing a cross-section of another filter media including multiple layers according to one set of embodiments;

FIG. 2D is a schematic diagram showing a cross-section of another filter media including multiple layers according to one set of embodiments;

FIG. 3A is a schematic diagram showing a modified surface of one of the layers according to one set of embodiments; and

FIG. 3B is a schematic diagram showing a cross-section of a filter media according to one set of embodiments.

### DETAILED DESCRIPTION

Filter media comprising fine staple fibers and related components, systems, and methods associated therewith are provided. In some embodiments, a filter media may include a layer (e.g., a wet laid layer) comprising polymeric staple fibers having a relatively small average diameter (e.g., less than or equal to about 1 micron). The polymeric staple fiber layer may be designed to impart desirable properties to the filter media, such as a high particulate efficiency and/or high fluid separation efficiency, while having relatively minimal or no adverse effects on one or more properties of the filter media that are important for a given application. For instance, a polymeric staple fiber layer may be added to increase the particulate efficiency and/or fuel:water separation efficiency of a fuel filter media, and accordingly the resulting fuel filter element. This increase in efficiency may be achieved with the use of relatively low (or zero) amounts of glass fibers, which may be desirable in some filtering applications. The filter media, described herein, may be particularly well-suited for a variety of applications such as fuel filtration, hydraulic filtration, lube filtration, air filtration, and water filtration.

In some conventional filter media, high particulate efficiency and/or fluid separation efficiency can be achieved by adding one or more layers that may adversely affect one or more properties of the media, limit the utility of the media, and/or increase the difficulty and/or expense of manufacturing the filter media. For instance, the additional layer(s) designed to increase efficiency may comprise a material (e.g., glass fibers) that may be less desirable to use with certain filtration fluids and/or conditions. In some instances, the substantial thickness of certain additional layer(s) designed to increase efficiency combined with other features of the media (e.g., small mean pore size) may cause the pressure drop of the filter media to increase significantly. Post-fabrication processes, such as pleating, may also be affected by the thickness of certain additional layer(s). For instance, a thicker media may produce fewer pleats. As another example, the specific dust holding capacity (i.e., dust holding capacity per unit thickness) of the filter element may decrease due to more thickness. In some instances, certain additional layer(s) may significantly impact the ease of manufacturer of the filter media. For example, the additional layer(s) may require specialized equipment or techniques to manufacture the media, require equipment different from those that would form the other layers in the filter media, and/or may significantly increase the manufacturing time or steps required to fabricate the filter media. For example, certain additional layers designed to increase efficiency may require a lamination step, which, in some instances, may lead to a decrease in dust holding capacity due to the nip pressure and adhesive used. Accordingly, there is a need for layers that are able to impart beneficial properties, such as particulate and fluid separation efficiency, without adversely affecting one or more properties of the filter media and/or manufacturing of the filter media.

In some embodiments, a layer comprising fine polymeric staple fibers as described herein does not suffer from one or more limitations of conventional layers. Polymeric staple fibers having a relatively small average diameter can be used to form a layer, via common manufacturing processes (e.g., a wet laid process), that can provide high particulate efficiency and/or fluid separation efficiency, while having relatively minimal or no adverse effects on one or more properties of the filter media. In some embodiments, such a fine polymeric staple fiber layer may comprise a relatively high weight percentage of fine polymeric staple fibers. For example, the layer may comprise greater than or equal to about 50%, greater than or equal to about 75%, greater than or equal to about 90%, greater than or equal to about 95%, or 100% of the total fibers in the layer by weight. Without wishing to be bound by theory, it is believed that the small fiber diameter coupled with a relatively high weight percentage of polymeric staple fibers in the layer can allow the layer to have a relatively high surface area, a relatively small “Perm. Pore Index” (defined as a [mean flow pore (μm)/(permeability (CFM))^{0.5}]; e.g., less than or equal to about 6, less than or equal to about 5, less than or equal to about 4, less than or equal to about 3.5, less than or equal to about 3, or less than or equal to about 2.5), and/or a relatively small thickness (e.g., less than or equal to about 0.2 mm), resulting in a relatively high specific dust holding capacity and/or a high particulate efficiency.

In some embodiments, the composition of the fine polymeric staple fibers in the layer may be selected to impart other desirable properties. For instance, certain fine polymeric staple fibers (e.g., hydrophobic fibers) may be used to form a layer having a specific wettability. The wettability of the fine polymeric staple fiber layer in combination with features, such as wettability, of another layer in the filter media may impart high fluid separation efficiency to the filter media. In certain embodiments, the composition of the fine polymeric staple fibers may be selected such that in addition to having a relatively high efficiency the polymeric staple fiber layer may contain little or no material that would be undesirable for a given filtering application.

In certain embodiments, the overall composition of one or more layers (e.g., layer including fine staple fibers, second layer) of the filter media may be designed to impart beneficial properties, such as enhanced fluid separation efficiency. For instance, in some embodiments, a filter media may comprise two or more layers designed to enhance fluid separation efficiency (e.g., fuel-water separation efficiency). One or more of the layers (e.g., layer including fine staple fibers, second layer) may have at least a portion of a surface that is modified to alter and/or enhance the wettability of the surface with respect to a particular fluid (e.g., the fluid to be separated). In some such cases, the wettability of a modified layer in combination with features, such as wettability, of another layer in the filter media may impart high fluid separation efficiency to the filter media.

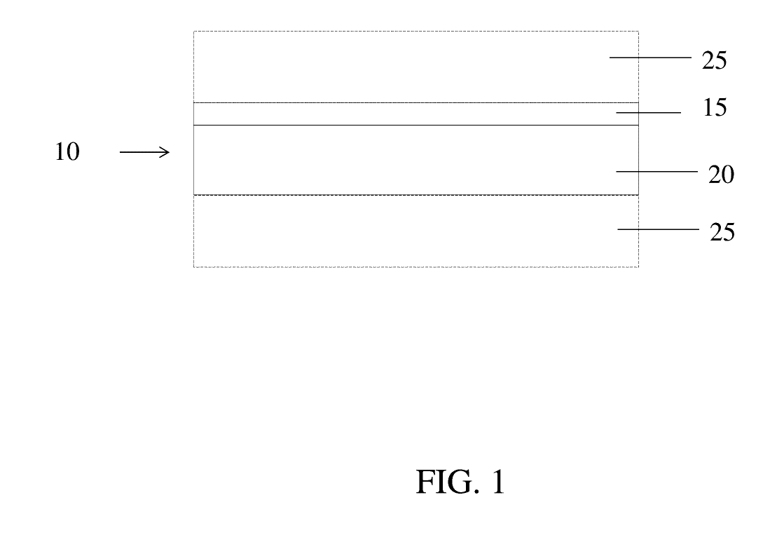

As described herein, a layer comprising polymeric staple fibers having a relatively small average diameter (e.g., less than or equal to about 1 micron, less than or equal to about 500 microns) may be used in a filter media to provide high particulate efficiency and/or high fluid separation efficiency. A non-limiting example of a filter media comprising such a layer is shown in FIG. 1. In some embodiments, a filter media 10 may include a first layer 15 that comprises fine polymeric staple fibers and a second layer 20. In certain embodiments, layers 15 and 20 may be directly adjacent as shown in FIG. 1.

As used herein, when a layer is referred to as being “adjacent” another layer, it can be directly adjacent the layer, or an intervening layer also may be present. A layer that is “directly adjacent” another layer means that no intervening layer is present.

In some such embodiments, the fine staple fiber layer may be formed on layer 20. For example, layers 15 and 20 may be formed together using a wet laid process. In another example, layer 20 may be formed via a non-wet laid process (e.g., meltblown, electrospun, air laid, spunbond, spunlace, forcespun, carding) and layer 15 may be formed on the non-wet laid layer. In some embodiments in which layer 15 and 20 are directly adjacent, the layers may be held together using resin (and/or physical interactions between the fibers of the layers), and an adhesive or bonding process is not used. In other embodiments, layer 15 may be attached to layer 20 via an adhesive or another bonding process. In some embodiments, layers 15 and 20 may be indirectly adjacent to one another, and one or more intervening layers (e.g., scrim layer, mesh) may separate the layers. In certain embodiments, the layer including the fine polymeric staple fibers may be upstream of the second layer as shown in FIG. 1. In other embodiments, the layer including the fine polymeric staple fibers may be downstream of the second layer.

In some embodiments, second layer 20 may have one or more properties that differ from first layer 15 (e.g., the layer including fine polymeric staple fibers). For instance, the second layer may comprise fibers having a greater average diameter than the first layer. In some such cases, the second layer may comprise fibers having an average diameter of greater than or equal to about 4 microns. In some instances, the second layer does not include any fine polymeric staple fibers (e.g., polymeric staple fibers having an average diameter of less than or equal to about 3 microns, or less than or equal to about 1 micron). In some cases, the second layer does not include any polymeric staple fibers at all. In some embodiments, the second layer may have a different wettability than the first layer. For instance, in some embodiments, the first layer may have a greater hydrophobicity than the second layer. In some such embodiments, the first layer may be hydrophobic and the second layer may be hydrophilic. In other embodiments, the wettability of the first layer and the second layer may be similar. In certain cases, the second layer may have a greater hydrophobicity than the first layer. In some embodiments, the difference in wettability between layers 15 and 20 may cause the filter media to have a high fluid separation efficiency, as described in more detail below.

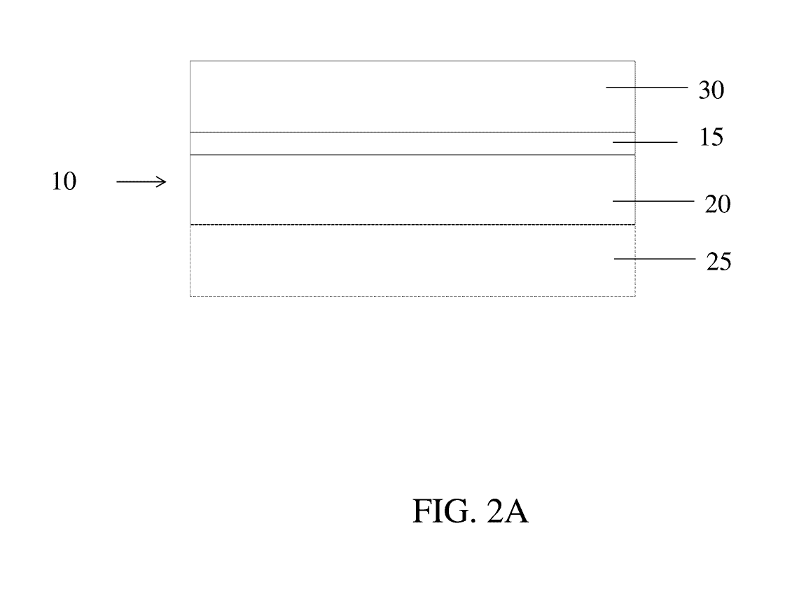

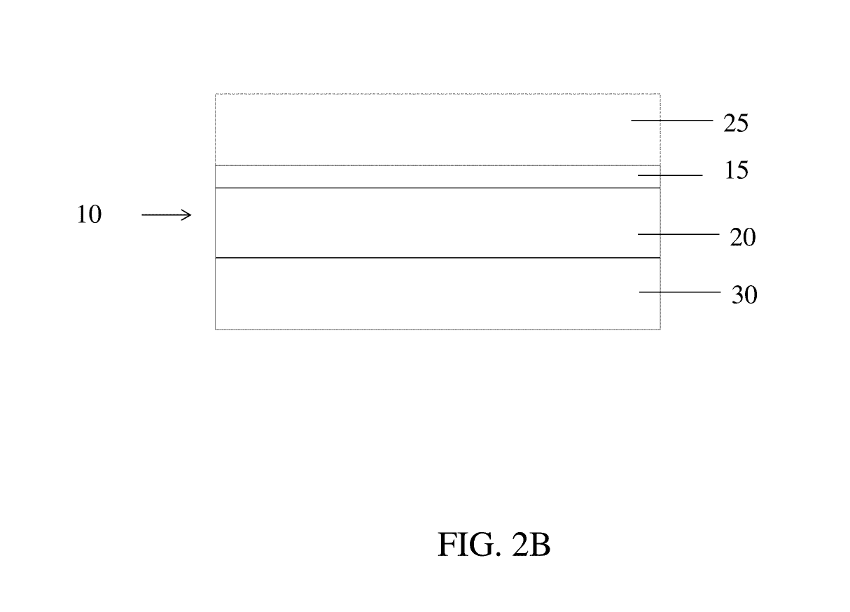

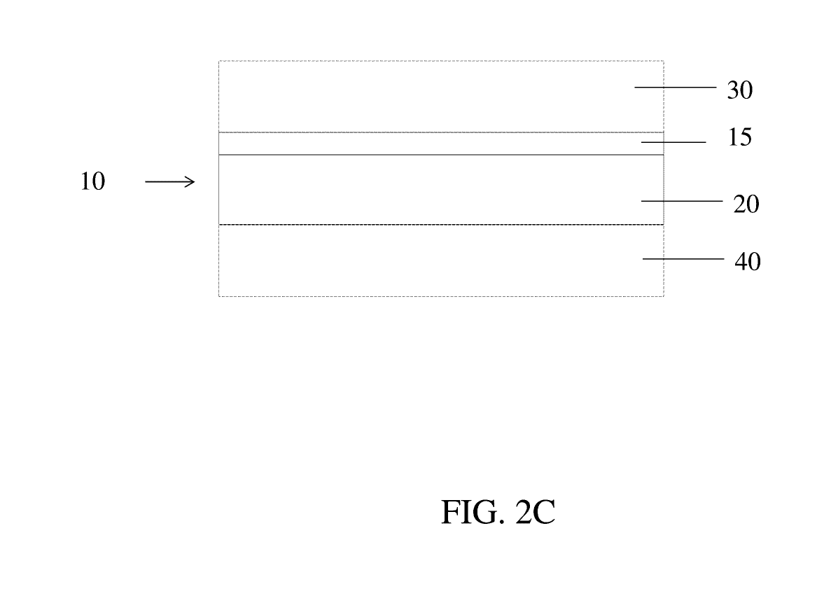

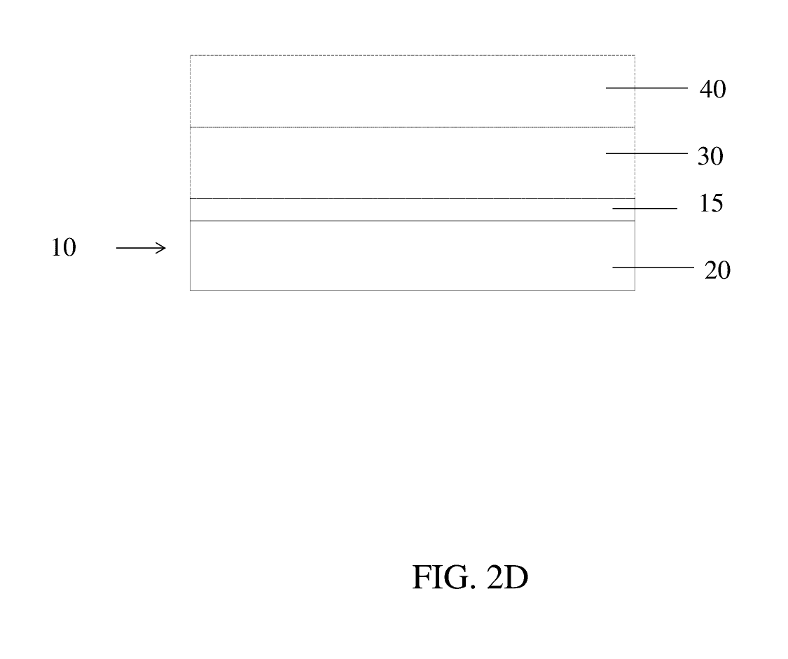

In some embodiments, filter media 10 may comprise one or more optional layers 25 positioned upstream and/or downstream of first layer 15 as illustrated in FIG. 1. The one or more optional layers may be any suitable layer. For instance, in some embodiments, one or more optional layers may be a support layer (e.g., mesh), a spacer layer, a scrim, a substrate layer, an efficiency layer (e.g., a layer that primarily serves to increase the efficiency or beta ratio of the filter media (ratio of the upstream average particle count (C₀) to the downstream average particle count (C)), a drainage layer (e.g., a layer that serves to prevent oversaturation of the filter media and allows for liquid drainage), and/or a capacity layer (e.g., a layer that serves to retain particulate matter and prevent clogging of another layer). In some embodiments, the filter media may comprise three or more layers. For instance, filter media 10 may comprise layer 15 including fine staple fibers, layer 20, and third layer 30 as shown in FIGS. 2A-2B. In certain embodiments, layer 30 may be a support layer that serves to provide support and strength to the filter media without adversely affecting one or more filtration properties (e.g., pressure drop, air permeability, efficiency). In some instances, the support layer may be a mesh support layer (e.g., synthetic mesh, metallic mesh), such as a layer formed of a wire or a non-fibrous layer. In some cases, third layer 30 may be a layer (e.g., meltblown layer) that serves to enhance one or more filtration properties (e.g., lifetime, dust holding capacity, efficiency). In some such embodiments, the third layer may be a non-wetlaid layer. Regardless of the function of the third layer, in some embodiments, third layer 30 may be upstream of layer 15. For example, layer 30 may be positioned upstream of layers 15 and 20 as shown in FIG. 2A. In certain embodiments, third layer 30 may be downstream of layer 20. For example, layer 30 may be positioned downstream of layers 15 and 20 as shown in FIG. 2B.

In some embodiments in which the filter comprises first layer 15, second layer 20, and third layer 30, the filter media may also comprise a fourth layer 40 as illustrated in FIGS. 2C-2D. In some such embodiments, the fourth layer may be substantially the same as or different than third layer 30 in composition and/or function. For instance, the fourth layer may have substantially the same composition as the third layer (e.g., substantially the same fiber type, substantially the same weight percentage of fibers). In some cases, the fourth layer may have substantially the same function as the third layer. For example, filter media 10 may comprise first layer 15 (e.g., the layer including fine polymeric staple fibers), second layer 25, and two scrim layers (e.g., the third and fourth layers). In some such embodiments, one scrim layer may be upstream of first layer 15 and the other scrim layer may be downstream of first layer 15 and/or second layer 20. In some embodiments, the fourth layer may have substantially the same function as the third layer. In embodiments in which the third and fourth layers serve substantially the same function, the third and fourth layers may have the same or different compositions. In some embodiments, the fourth layer may have a different composition than the third layer. For example, fourth layer 40 may be fibrous layer (e.g., meltblown layer) and third layer 30 may be a non-fibrous layer (e.g., wire mesh). In certain embodiments in which the third and fourth layers have different compositions, the third and fourth layer may have substantially the same function. In some cases, the fourth layer may have a different function than the third layer.

In some embodiments, third layer 30 (e.g., support layer, meltblown layer) may be upstream of first layer 15 and fourth layer 40 (e.g., meltblown layer, support layer) may be downstream of first layer 15. For instance, third layer 30 may be upstream of layers 15 and 20 and layer 40 may be downstream of layers 15 and 20 as shown in FIG. 2C. Alternatively, layer 30 may be downstream of layers 15 and 20 and layer 40 may be upstream of layers 15 and 20. In certain embodiments, layers 30 and 40 may both be upstream or downstream of layers 15 and/or 20. For instance, as shown in FIG. 2D, layers 30 and 40 may both be upstream of layer 15. In some such embodiments, layers 30 and 40 may be directly adjacent to one another, as shown in FIG. 2D, or indirectly adjacent to one another.

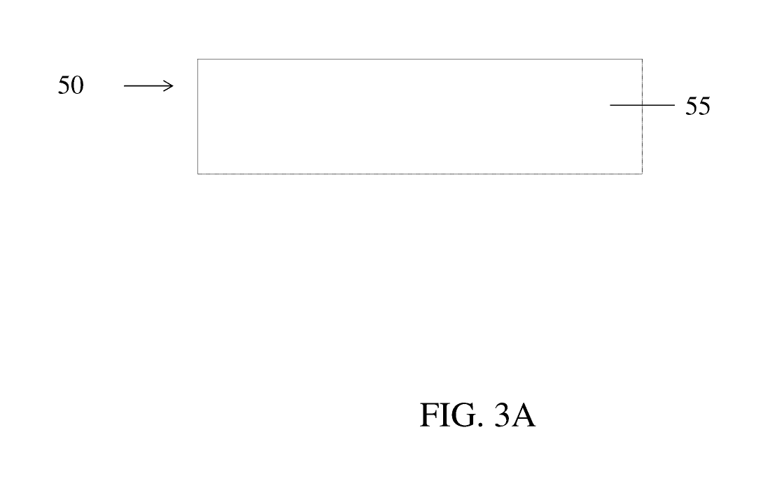

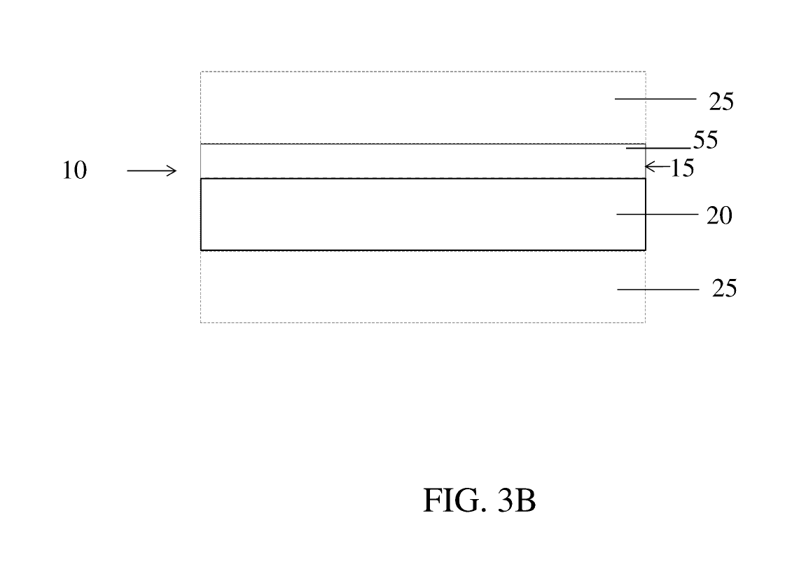

As described herein, in some embodiments, the filter media may include one or more modified layers. An example of a modified layer and a filter media comprising one or more modified layers can be seen in FIGS. 3A-3B. As shown illustratively in FIG. 3A, at least a portion of layer 50 (e.g., surface(s) and/or interior, entire layer) may be modified with a material 55. In some embodiments, the layer (e.g., a surface(s) and/or interior of a layer) may be modified to alter and/or enhance the wettability of at least a portion of the layer (e.g., at least one surface of a layer) with respect to a particular fluid (e.g., to make a layer more hydrophilic, or more hydrophobic). In one example, a hydrophilic surface having a water contact angle of 60° may be modified to have a water contact angle of less than 60°, such as 15°. In another example, a hydrophobic surface having a water contact angle of 100° may be modified to have a water contact angle of greater than 100°, such as 130° or greater. In some embodiments, the modification (e.g., surface modification) may alter the hydrophilicity or hydrophobicity of at least a portion of the layer (e.g., one surface of the layer), such that the layer has the opposite hydrophilicity or hydrophobicity, respectively. For example, a surface of a relatively hydrophobic layer may be modified with a hydrophilic material (e.g., charged material, organic hydrophilic material, inorganic materials such as alumina, silica, metals), such that the modified surface is hydrophilic. Alternatively, in certain embodiments, a relatively hydrophilic layer may be modified with a hydrophobic material, such that the modified portion (e.g., surface(s) and/or interior, entire layer) is hydrophobic. In some embodiments, the layer may have one modified surface (e.g., upstream surface) and one unmodified surface (e.g., downstream surface). In other embodiments, the layer may have two or more modified surfaces (e.g., the upstream and downstream surfaces). In some embodiments, the entire layer may be modified. For example, the interior and the surfaces of the layer may be modified. In certain embodiments, the interior of the layer may be modified without one or more outer surfaces of the layer being modified. For example, filter media may undergo a coating process (e.g., chemical vapor deposition), such that one or more outer surfaces of an interior layer and/or bottom layer is not coated, while the porous interior of the layer is coated.

In general, any suitable layer in the filter media may be a modified layer. In some embodiments, as shown in FIG. 3B, filter media may comprise one or more layers having a material on at least a portion of one or more surfaces and/or the interior. For instance, filter media 10 may comprise a first layer 15 (e.g., including fine staple fibers) having a material 55 on at least one surface and/or the interior of the first layer (e.g., a modified first layer), a second layer 20, and one or more optional layers 25 (e.g., support layer, meltblown layer), as shown in FIG. 3B. In certain embodiments, a filter media may comprise a first layer 15 (e.g., including fine staple fibers), a second layer having a material on at least one surface (e.g., a surface modified second layer), and one or more optional layers 25 (e.g., support layer, meltblown layer). In some instances, a filter media may comprise a first layer 15 (e.g., including fine staple fibers) having a material on at least one surface and/or the interior, a second layer having a material on at least one surface (e.g., a surface modified second layer), and one or more optional layers 25. In some cases, a filter media may comprise a first layer 15 (e.g., including fine staple fibers) having a material on at least one surface and/or the interior, a second layer having a material on at least one surface (e.g., a modified second layer) and/or the interior, and one or more optional layers 25 having a material on at least one surface and/or the interior (e.g., a modified layer). In some embodiments, each layer in the filter media may be a modified layer. In certain embodiments, each fibrous layer in the filter media may be a modified layer. In some embodiments, less than or equal to two layers (e.g., two layers, one layer) in a filter media may be a modified layer. As described herein, a modified layer may have only a surface of the layer that is modified with a material, both surfaces of the layer that are modified with the material, only the interior of the layer that is modified with a material, or the entire layer may be modified with the material.

In some embodiments in which the filter media is used for fluid separation, the surface(s) and/or interior of one or more layers may be modified to be wetting toward the fluid to be separated. In some such embodiments, the wetting surface and/or interior may be used to cause at least a portion of droplets of the fluid to be separated to coalesce, such that the droplets have the requisite size for removal at a subsequent layer and/or such that the coalesced droplets are able to be separated (e.g., via gravity) at the wetting portion of the layer (e.g., surface, interior). In some embodiments, the surface of one or more layers may be modified to repel the fluid to be separated. For instance, the repelling surface may substantially block the transport of droplets of the fluid to be separated, such that droplets of a certain size may be inhibited from flowing across the layer having the repelling surface and are separated (e.g., shed) from the filtration fluid.

In some embodiments, the filter media may comprise at least one modified layer having a wetting surface or repelling surface as described above. In certain embodiments, the filter media may comprise a modified layer having both a wetting surface and a modified layer having a repelling surface.

It should be understood that the configurations of the layers shown in the figures are by way of example only, and that in other embodiments, filter media including other configurations of layers may be possible. For example, while the first and second (and optional third, fourth, etc.) layers are shown in a specific order in FIGS. 1-3, in other embodiments, the optional third layer may be positioned between the first and second layers. In other embodiments, the first layer may be positioned between the second and optional third layers. In yet other embodiments, one or more intervening layers, such as non-modified layer(s) may be present between two layers. Other configurations are also possible. Additionally, it should be appreciated that the terms “first”, “second”, “third” and “fourth” layers, as used herein, refer to different layers within the media, and are not meant to be limiting with respect to the particular function of that layer. For example, while a “first” layer may be described as including fine staple fibers in some embodiments, in other embodiments, a “first” layer may not include fine staple fibers. Furthermore, in some embodiments, additional layers (e.g., “fifth”, “sixth”, or “seventh” layers) may be present in addition to the ones shown in the figures. For instance, in some embodiments, a filter media or filter arrangement may comprise up to about twenty layers. It should also be appreciated that not all components shown in the figures need be present in some embodiments. For instance, in some embodiments, the filter media may not comprise a third layer and/or a modified layer.

As described herein, in some embodiments, a layer of filter media may comprise polymeric staple fibers having a relatively small average diameter. In some embodiments, the fine polymeric staple fibers within the layer may have an average diameter of less than or equal to about 11 microns, less than or equal to about 10 microns, less than or equal to about 8 microns, less than or equal to about 6 microns, less than or equal to about 4 microns, less than or equal to about 3 microns, less than or equal to about 2 microns, less than or equal to about 1 microns, less than or equal to about 0.8 microns, less than or equal to about 0.5 microns, less than or equal to about 0.2 micron, or less than or equal to about 0.1 microns. In some instances, the average fiber diameter of the fine polymeric stable fibers within the layer may be greater than or equal to about 0.1 microns, greater than or equal to about 0.2 microns, greater than or equal to about 0.5 microns, greater than or equal to about 0.8 microns, greater than or equal to about 1 micron, or greater than or equal to about 3 microns. Combinations of the above-referenced ranges are also possible. For instance, in certain embodiments, the average diameter of the polymeric staple fibers may be, for example, greater than or equal to about 0.1 microns and less than or equal to about 11 microns, greater than or equal to about 0.1 microns and less than or equal to about 3 microns, greater than or equal to about 0.1 microns and less than or equal to about 1 micron, greater than or equal to about 0.1 microns and less than or equal to about 0.8 microns, or greater than or equal to about 0.1 microns and less than or equal to about 0.5 microns. In some embodiments, the polymeric staple fibers have an average diameter of less than 1 micron.

Generally, the polymeric stable fibers are non-continuous fibers. That is, the polymeric staple fibers are generally cut (e.g., from a filament) or formed as non-continuous discrete fibers to have a particular length or a range of lengths. In some embodiments, the polymeric staple fibers may have a length of less than or equal to about 20 cm, less than or equal to about 10 cm, less than or equal to about 5 cm, less than or equal to about 10 mm, less than or equal to about 6 mm, less than or equal to about 5 mm, less than or equal to about 3 mm, less than or equal to about 2 mm, less than or equal to about 1 mm, less than or equal to about 0.75 mm, less than or equal to about 0.5 mm, less than or equal to about 0.2 mm, less than or equal to about 0.1 mm, less than or equal to about 0.05 mm, less than or equal to about 0.02 mm. In some instances, the polymeric staple fibers may have a length of greater than or equal to about 0.005 mm, greater than or equal to about 0.01 mm, greater than or equal to about 0.02 mm, greater than or equal to about 0.05 mm, greater than or equal to about 0.1 mm, greater than or equal to about 0.2 mm, greater than or equal to about 0.5 mm, greater than or equal to about 0.75 mm, greater than or equal to about 1 mm, greater than or equal to about 5 mm, greater than or equal to about 10 mm, greater than or equal to about 5 cm, or greater than or equal to about 10 cm. Combinations of the above-referenced ranges are possible (e.g., greater than or equal to about 0.005 mm and less than or equal to about 20 cm, greater than or equal to about 0.01 mm and less than or equal to about 10 cm, greater than or equal to about 1 mm and less than or equal to about 6 mm).

In general, the polymeric staple fibers (e.g., a first, second, third, fourth, etc. plurality of polymeric staple fibers) may have any suitable composition. Non-limiting examples of the materials (e.g., polymers) that can be used to form the polymeric staple fibers include polyester (e.g., polycaprolactone), cellulose acetate, polymethyl methacrylate, polystyrene, polyaniline, polypropylene, polyamide, polyaramid (e.g. para-aramid, meta-aramid), polyimide (e.g., polyetherimide (PEI)), polyethylenes, polyether ketone, polyethylene terephthalate, polyolefin, nylon, polyacrylics, polyvinylalcohol, polyether sulfones, poly(phenylene ether sulfone), polysulfones, polyacrylonitrile, polyvinylidene fluoride, polybutylene terephthalate, poly(lactic acid), polyphenylene oxide, polycarbonate, polyurethane, polyethylene imine, polyaziridines, polypyrrole, zein, polyimines, polyvinyl butyral, phenyl-formaldehyde polymers, silicone, polyethylene glycol, and combinations or copolymers (e.g., block copolymers) thereof. Those of ordinary skill in the art would be able to readily select hydrophobic fibers, hydrophilic fibers, or fibers with the requisite inherent wettability.

The polymeric staple fibers may have any suitable configuration. For example, in some embodiments, the polymeric staple fibers are monocomponent fibers; however, in other embodiments, the polymeric staple fibers are multicomponent fibers. In some cases, the polymeric staple fibers may be crimped. In other cases, the polymeric staple fibers are non-crimped. Other configurations are also possible.

In some embodiments, the layer including fine polymeric fibers may comprise a relatively high weight percentage of fine staple fibers. In some embodiments, the weight percentage of fine polymeric staple fibers in the layer may be greater than or equal to about 0.5%, greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, greater than or equal to about 80%, or greater than or equal to about 90% by weight, e.g., based on the total weight of fibers in the layer. In some instances, the weight percentage of fine polymeric staple fibers in the layer may be less than or equal to about 100%, less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, or less than or equal to about 5% by weight, e.g., based on the total weight of fibers in the layer. Combinations of the above-referenced ranges are possible (e.g., greater than or equal to about 0.5% and less than or equal to about 100%, greater than or equal to about 1% and less than or equal to about 100%, greater than or equal to about 50% and less than or equal to about 100%, greater than or equal to about 70% and less than or equal to about 100%, greater than or equal to about 90% and less than or equal to about 100%). In some embodiments, the weight percentage of fine polymeric staple fibers in the layer may be 100%. In some embodiments, the above weight percentages are based on the weight of the total dry solids of the layer (including any resins).

In some embodiments, the layer including fine polymeric staple fibers can include other fibers (e.g., fibers other than fine polymeric staple fibers) as described in more detail below.

In some embodiments, the layer including fine polymeric staple fibers may be relatively thin. In some such embodiments, the layer may have a relatively high specific dust holding capacity and/or low pressure drop compared to a similar layer of the same or greater thickness but including continuous fibers instead of fine polymeric staple fibers, all other factors being equal.

In some embodiments, the thickness of the layer including fine polymeric staple fibers may be less than or equal to about 1 mm, less than or equal to about 0.9 mm, less than about 0.8 mm, less than or equal to about 0.7 mm, less than or equal to about 0.6 mm, less than or equal to about 0.5 mm, less than or equal to about 0.4 mm, less than or equal to about 0.3 mm, less than or equal to about 0.2 mm, less than or equal to about 0.1 mm, less than or equal to about 0.09 mm, or less than or equal to about 0.08 mm. In some instances, the thickness of the filter media may be greater than or equal to about 0.03 mm, greater than or equal to about 0.04 mm, greater than or equal to about 0.05 mm, greater than or equal to about 0.06 mm, greater than or equal to about 0.07 mm, greater than or equal to about 0.08 mm, greater than or equal to about 0.09 mm, greater than or equal to about 0.1 mm, greater than or equal to about 0.2 mm, greater than or equal to about 0.3 mm, greater than or equal to about 0.4 mm, greater than or equal to about 0.5 mm, or greater than equal to 0.6 mm. Combinations of the above-referenced ranges are possible (e.g., greater than or equal to about 0.03 mm and less than or equal to about 1 mm, greater than or equal to about 0.05 mm and less than or equal to about 1 mm, greater than or equal to about 0.03 mm and less than or equal to about 0.2 mm, greater than or equal to about 0.05 mm and less than or equal to about 0.2 mm). Other values of thickness of the filter media are possible. The thickness may be determined according to the standard ISO 534 (2011) at 2 N/cm².

In some embodiments, the layer including fine polymeric staple fibers may have a basis weight of greater than or equal to about 0.5 g/m², greater than or equal to about 1 g/m², greater than or equal to about 2 g/m², greater than or equal to about 5 g/m², greater than or equal to about 10 g/m², greater than or equal to about 20 g/m², greater than or equal to about 30 g/m², greater than or equal to about 40 g/m², greater than or equal to about 50 g/m², greater than or equal to about 60 g/m², greater than or equal to about 70 g/m², greater than or equal to about 80 g/m², or greater than or equal to about 90 g/m². In some instances, the filter media may have a basis weight of less than or equal to about 100 g/m², less than or equal to about 90 g/m², less than or equal to about 80 g/m², less than or equal to about 70 g/m², less than or equal to about 60 g/m², less than or equal to about 50 g/m², less than or equal to about 40 g/m², less than or equal to about 30 g/m², less than or equal to about 20 g/m², less than or equal to about 10 g/m², less than or equal to about 5 g/m², less than or equal to about 2 g/m², or less than or equal to about 1 g/m². Combinations of the above-referenced ranges are possible (e.g., greater than or equal to about 0.5 g/m² and less than or equal to about 100 g/m², greater than or equal to about 0.5 g/m² and less than or equal to about 50 g/m²). Other values of basis weight are possible. The basis weight may be determined according to the standard ISO 536 (2012).

The mean flow pore size may be selected as desired. For instance, in some embodiments, the layer including fine polymeric staple fibers may have a mean flow pore size of greater than or equal to about 0.05 microns, greater than or equal to about 0.1 microns, greater than or equal to about 0.15 microns, greater than or equal to about 0.2 microns, greater than or equal to about 0.5 microns, greater than or equal to about 1 micron, greater than or equal to about 10 microns, greater than or equal to about 25 microns, greater than or equal to about 50 microns greater than or equal to about 75 microns, greater than or equal to about 100 microns, or greater than or equal to about 125 microns. In some instances, the layer including fine polymeric staple fibers may have a mean flow pore size of less than or equal to about 150 microns, less than or equal to about 125 microns, less than or equal to about 100 microns, less than or equal to about 75 microns, less than or equal to about 50 microns, less than or equal to about 25 microns, less than or equal to about 10 microns or less than or equal to about 1 micron. Combinations of the above-referenced ranges are also possible (e.g., greater than or equal to about 0.05 microns and less than or equal to about 150 microns, greater than or equal to about 0.1 microns and less than or equal to about 150 microns, greater than or equal to about 0.15 microns and less than or equal to about 100 microns, greater than or equal to about 0.2 microns and less than or equal to about 100 microns, greater than or equal to about 1 micron and less than or equal to about 150 microns). Other values of mean flow pore size are also possible. The mean flow pore size may be determined according to the standard ASTM F316 (2003).

In some embodiments, the layer including fine polymeric staple fibers described herein, and/or a filter media including such a layer, may have a certain relationship between mean flow pore size to permeability. The relationship between mean flow pore size and permeability may be expressed as [mean flow pore (μm)/(permeability (CFM))^{0.5}], also referred to herein as the Perm. Pore Index. In other words, the mean flow pore size of the layer or filter media may be divided by the square root of the permeability of the layer or filter media, respectively. In some embodiments, a layer including fine polymeric staple fibers described herein, and/or a filter media including such a layer, may have a [mean flow pore (μm)/(permeability (CFM))^{0.5}] value of between about 0.5 and about 6.0. In some embodiments, a layer and/or a filter media has a [mean flow pore (μm)/(permeability (CFM))^{0.5}] value of less than or equal to about 6, less than or equal to about 5, less than or equal to about 4, less than or equal to about 3, less than or equal to about 2.5, less than or equal to about 2, less than or equal to about 1.8, less than or equal to about 1.6, less than or equal to about 1.5, less than or equal to about 1.4, less than or equal to about 1.2, less than or equal to about 1.0, less than or equal to about 0.9, less than or equal to about 0.8, less than or equal to about 0.7, or less than or equal to about 0.6. In some embodiments, a layer and/or a filter media has a [mean flow pore (μm)/(permeability (CFM))^{0.5}] value of greater than or equal to about 0.5, greater than or equal to about 0.6, greater than or equal to about 0.8, greater than or equal to about 1.0, greater than or equal to about 1.2, greater than or equal to about 1.5, greater than or equal to about 2.0, greater than or equal to about 3.0, greater than or equal to about 4.0, or greater than or equal to about 5.0. Combinations of the above-referenced ranges are also possible (e.g., a [mean flow pore (μm)/(permeability (CFM))^{0.5}] value of greater than about 0.5 and less than or equal to about 3.0). Other values are also possible.

As described herein, a filter media may comprise a layer including fine polymeric staple fibers and a second layer. In some embodiments, the second layer may comprise relatively coarse fibers. For instance, in some embodiments, the average diameter of fibers in the second layer may be greater than or equal to about 1 microns, greater than or equal to about 2 microns, greater than or equal to about 3 microns, greater than or equal to about 4 microns, greater than or equal to about 5 microns, greater than or equal to about 6 microns, greater than or equal to about 7 microns, greater than or equal to about 8 microns, greater than or equal to about 9 microns, greater than or equal to about 10 microns, greater than or equal to about 12 microns, greater than or equal to about 15 microns, greater than or equal to about 20 microns, greater than or equal to about 30 microns, greater than or equal to about 40 microns, greater than or equal to about 50 microns, greater than or equal to about 60 microns, greater than or equal to about 70 microns, greater than or equal to about 80 microns, or greater than or equal to about 90 microns. In some instances, the average diameter of the fibers in the second layer may be less than or equal to about 100 microns, less than or equal to about 90 microns, less than or equal to about 80 microns, less than or equal to about 70 microns, less than or equal to about 60 microns, less than or equal to about 50 microns, less than or equal to about 40 microns, less than or equal to about 30 microns, less than or equal to about 20 microns, less than or equal to about 18 microns, less than or equal to about 15 microns, less than or equal to about 12 microns, less than or equal to about 10 microns, less than or equal to about 9 microns, less than or equal to about 8 microns, less than or equal to about 7 microns, less than or equal to about 6 microns, less than or equal to about 5 microns, or less than or equal to about 4 microns. Combinations of the above-referenced ranges are also possible (e.g., greater than or equal to about 4 microns and less than or equal to about 20 microns, greater than or equal to about 4 microns and less than or equal to about 15 microns). In some embodiments, the average diameter of the fibers in the second layer is greater than about 1 micron and less than or equal to about 4 microns (e.g., greater than about 1 micron and less than or equal to about 2 microns, greater than or equal to about 2 micron and less than or equal to about 3 microns, greater than or equal to about 3 micron and less than or equal to about 4 microns.) Other values of average fiber diameter are also possible.

In some embodiments, the second layer may be a wet laid layer. In other instances, the second layer may be a non-wet laid layer. Non-limiting examples of suitable non-wet laid layers include a meltblown layer, an air laid layer, a spunbond layer, a mesh layer, a forcespun layer, a spunlace layer, a needlepunched layer, a carded layer, or an electrospun layer, a forcespun layer. In certain embodiments, the second layer may be a single layer or comprise a plurality of sub-layers (e.g., 2 sub-layers, 3 sub-layers, 4 sub-layers, 5 sub-layers, 6 sub-layers, 7 sub-layers, 8 sub-layers, 9 sub-layers, 10 sub-layers). In some such embodiments, the second layer may be a composite layer.

As described herein, a filter media may comprise a layer including fine polymeric staple fibers, a second layer, and one or more optional layers. In some embodiments, one or more optional layers (e.g., third layer, fourth layer) may serve as a support for one or more layers of the filter media and/or the entire filter media. For example, the filter media may comprise a support layer in addition to the first and second layers. The support layer may help to maintain or enhance certain filtration properties (e.g., efficiency, dust holding capacity) by, e.g., improving the mechanical integrity of one or more layers of the filter media and/or the entire filter during filtration. For example, in one embodiment, a pleated filter media may comprise a support layer (e.g., an expanded metal wire, an extruded plastic mesh) that aids in the retention of the pleated configuration during filtration due, at least in part, to the increase Gurley stiffness provided by the support layer. The support layer may help retain a given filter media shape and/or provide support to filter media against the fluid stream during filtration. For instance, in some embodiments, the support layer(s), described herein, may provide sufficient stiffness to a pleated filter media to allow most or substantially all of the pleats to maintain their relatively uniform separation during filtration. The retention of the filter media shape during filtration may allow for beneficial fluid flow patterns (e.g., relatively uniform exposure of the filter media to the filtration fluid) through the filter media and accordingly improved efficiency, dust holding capacity, and water separation efficiency compared to essentially the same filter media lacking the support layer.

In some embodiments, the support layer (e.g., third layer) may be a mesh (e.g., synthetic mesh). In certain embodiments, the mesh may have a higher Gurley stiffness than certain woven and/or nonwoven layers and may be particularly well-suited for maintaining the shape of a filter media and/or provide support to filter media against the fluid stream during filtration. Non-limiting examples of meshes that may be used include metallic meshes (e.g., wire meshes, stainless steel meshes) and synthetic meshes (e.g., plastic meshes, polymer meshes). In some embodiments, a mesh may be woven, knitted, welded, expanded, photo-chemically etched, or an electroformed layer, each of which may be derived from metal and/or plastic. In general, a mesh may be a loosely woven or knitted fabric that has a relatively large number of closely spaced holes.

In some embodiments, the filter media may comprise a layer (e.g., meltblown layer) designed to enhance one or more filtration properties (e.g., filtration layer) in addition to the first and second layers. The filtration layer may, for example, enhance the lifetime, water separation efficiency, and/or dust holding capacity of the filter media. In some embodiments, the filtration layer may be designed to enhance water separation efficiency. In some such embodiments, the filtration layer may be a modified layer as described herein. In other embodiments, however, the filtration layer is not a modified layer. In certain embodiments, the filtration layer may be a meltblown layer. For instances, the filtration may be a meltblown layer having a basis weight of greater than or equal to about 3 g/m² and less than or equal to about 400 g/m² (e.g., greater than or equal to about 5 g/m² and less than or equal to about 300 g/m², greater than or equal to about 25 g/m² and less than or equal to about 300 g/m²) and an air permeability of less than or equal to about 800 CFM (e.g., less than or equal to about 500 CFM) and greater than or equal to about 5 CFM (e.g., greater than or equal to about 8 CFM).

In some embodiments, the layer including fine polymeric staple fibers may be used to impart high fluid separation efficiency to the filter media. In some such embodiments, the polymeric staple fiber layer may be designed to have a specific wettability and/or a wettability that differs from one or more layers in the filter media (e.g., the second layer). The composition of the fine polymeric staple fibers in the layer may be selected such that the inherent wetting properties of the fine polymeric staple fibers can be used to produce the desired wettability with respect to a particular fluid (e.g., the fluid to be separated). For example, hydrophobic fine polymeric staple fibers or hydrophilic fine polymeric staple fibers may be used to form a layer that is hydrophobic or hydrophilic, respectively. In another example, a blend of fine polymeric staple fibers having different wettabilities with respect to a particular fluid may be used to form a layer having a specific wettability.

In some embodiments, one or more modified layers (e.g., one or more layers including fine polymeric staple fibers, a second layer, a third layer, an optional layer) may be used to impart high fluid separation efficiency to the filter media. The increased fluid separation may be achieved, in some instances, by having a surface modification that allows the layer to coalesce and/or repel the fluid to be separated (e.g., water, hydraulic fluid, oil) from the filtration fluid (e.g., hydraulic fluid, fuel, water, air). In other embodiments, the surface modification allows the layer to simply pass a fluid to be separated, such that the fluid can be separated in a downstream layer. In some instances, modifying the surface of a layer with a material may impart wetting characteristics that are difficult to achieve, or cannot be achieved, using fibers alone. For instance, in some embodiments, processing conditions may limit the ability of a material having a relatively high hydrophobicity to be formed into fibers, thus preventing the formation of a relatively high hydrophobic surface using the fibers alone. However, by modifying the surface of an existing fiber web, a variety of hydrophobic materials may be used to provide a hydrophobic surface that is tailored to the degree of hydrophobicity. Similarly, certain processing and/or application constraints may limit the use of certain hydrophilic materials in fiber form; however, modifying the surface of an existing fiber web can allow certain hydrophilic materials to be used to impart a desired hydrophilicity to the surface.

In some such embodiments, one or more modified layers may be designed to have a specific wettability and/or a wettability that differs from one or more layers in the filter media (e.g., the second layer). In some embodiments, a filter media comprising two or more layers designed to enhance fluid separation efficiency (e.g., fuel-water separation efficiency) may include at least two modified layers. In certain embodiments, a filter media comprising two or more modified layers may have enhanced fluid separation efficiency compared to filter media having one or no modified layer. In some embodiments, a filter media comprising two or more layers designed to enhance fluid separation efficiency (e.g., fuel-water separation efficiency) may include at least one modified layers (e.g., two or more modified layers) and at least one layer that is intrinsically hydrophilic or hydrophobic. In certain embodiments, a filter media comprising at least one modified layer at least one layer that is intrinsically hydrophilic or hydrophobic may have enhanced fluid separation efficiency compared to filter media having one or no modified layer.

As used herein, the terms “wet” and “wetting” may refer to the ability of a fluid to interact with a surface such that the contact angle of the fluid with respect to the surface is less than 90 degrees. Accordingly the terms “repel” and “repelling” may refer to the ability of a fluid to interact with a surface such that the contact angle of the fluid with respect to the surface is greater than or equal to 90 degrees.

In general, the wettability of one or more layers (e.g., layer including fine polymeric staple fibers) may be selected to allow the layer to repel or coalesce the fluid to be separated (e.g., water, oil) from the filtration fluid (e.g., fuel, hydraulic fluid, water, air). In some instances, the surface of a layer (e.g., layer including fine polymeric staple fibers) may repel or coalesce the fluid to be separated. In other instances, repelling and coalescing may occur in the interior of the layer (e.g., layer including fine polymeric staple fibers). In some embodiments, a layer (e.g., layer including fine polymeric staple fibers) may be designed to repel the fluid to be separated. In such cases, a layer (e.g., layer including fine polymeric staple fibers) may substantially block the transport of droplets of the fluid to be separated, such that droplets of a certain size may be inhibited from flowing across such a repelling layer and are separated (e.g., shed) from the filtration fluid. In some embodiments, a layer (e.g., layer including fine polymeric staple fibers) may be designed to be wetting toward and coalesce the fluid to be separated. In such cases, a layer (e.g., layer including fine polymeric staple fibers) may be used to cause at least a portion of droplets of the fluid to be separated to coalesce, such that the droplets have the requisite size for removal at a subsequent layer and/or such that the coalesced droplets are able to be separated (e.g., via gravity) at the layer (e.g., layer including fine polymeric staple fibers).

In some embodiments, the filter media may comprise a coalescing or repelling first layer (e.g., layer including fine polymeric staple fibers), as described above, and a second layer having a different wettability with respect to a particular fluid than the first layer (e.g., layer including fine polymeric staple fibers). Such a media can be designed to both coalesce and repel droplets of the fluid to be separated. In certain embodiments, the first layer (e.g., layer including fine polymeric staple fibers) may repel, and the second layer may coalesce, the fluid to be separated. For example, a filter media designed to separate a hydrophilic fluid from a filtration fluid (e.g., a hydrophobic liquid) may comprise a hydrophobic layer including fine polymeric staple fibers upstream of a hydrophilic second layer. The upstream hydrophobic layer including fine polymeric staple fibers may serve to repel and remove hydrophilic droplets (e.g., via shedding) and the downstream hydrophilic second layer may serve to coalesce and remove (e.g., via gravity) at least a portion of remaining hydrophilic fluid in the filtration fluid. In some instances, the larger hydrophilic fluid droplets are shed upstream via the hydrophobic layer including fine polymeric staple fibers and the remaining hydrophilic fluid droplets are coalesced at the hydrophilic second layer to form larger droplets that are removed via gravity.

In another example, a filter media designed to separate hydrophilic fluid from a filtration fluid (e.g., a hydrophobic liquid) may comprise a hydrophilic second layer upstream of a hydrophobic layer including fine polymeric staple fibers. The upstream hydrophilic layer may serve to coalesce and remove (e.g., via gravity) hydrophilic droplets and the downstream hydrophobic layer including fine polymeric staple fibers may serve to remove at least a portion of remaining hydrophilic fluid in the filtration fluid. In some instances, hydrophilic fluid droplets coalesce at the hydrophilic second layer to form larger droplets that are removed via gravity or downstream via the hydrophobic layer including fine polymeric staple fibers. In other embodiments, the layer including fine polymeric staple fibers may coalesce and the second layer may repel the fluid to be separated. In some such embodiments, the layer including fine staple fibers is the hydrophilic layer in the examples described above and the second layer is the hydrophobic layer in the examples described above.

In some embodiments, the filter media may comprise a first layer including fine polymeric staple fibers and a second layer that has a similar or substantially the same wettability as the first layer with respect to a particular fluid. In some such embodiments, the filter media may repel or coalesce the fluid to be separated. For example, a filter media designed to remove a hydrophilic fluid from a filtration fluid may comprise a hydrophobic layer including fine polymeric staple fibers and a hydrophobic second layer. The hydrophobic layer including fine polymeric staple fibers may be upstream or downstream of the hydrophobic second layer. In certain embodiments, the downstream layer may serve to repel and shed fluid droplets that are not repelled and/or removed by the upstream layer. For example, the upstream layer may be designed to repel and/or remove relatively large droplets and the downstream layer may be designed to repel and shed smaller droplets that bypass the upstream layer. In another example, a filter media designed to remove a hydrophilic fluid from a filtration fluid may comprise a hydrophilic layer including fine polymeric staple fibers and a hydrophilic second layer. The hydrophilic layer including fine polymeric staple fibers may be upstream or downstream of the hydrophilic second layer. In certain embodiments, the downstream layer may serve to coalesce and/or remove fluid droplets that are not coalesced and/or removed by the upstream layer. For example, the upstream layer may be designed to coalesce and/or remove relatively large droplets and the downstream layer may be designed to coalesce and/or remove smaller droplets that bypass the upstream layer.

In some embodiments, one or more layers (e.g., layer including fine polymeric staple fibers) may serve to increase the overall average fluid separation efficiency of the filter media and/or a filter arrangement comprising the layer including fine polymeric staple fibers. In some embodiments, the average fluid (e.g., fuel-water) separation efficiency of the filter media may range from about 20% to about 99.99% or higher (e.g., between about 25% to about 99.99%, between about 30% to about 99.99%, between about 60% to about 99.99%). For instance, in certain embodiments, the average fluid separation efficiency of the filter media may be at least about 20%, at least about 25%, at least about 30%, at least about 40%, at least about 50%, at least about 60%, at least about 70%, at least about 80%, at least about 90%, at least about 95%, at least about 98%, at least about 99%, or at least about 99.5%. In some instances, the average fluid separation efficiency of the filter media may be less than or equal to about 99.99%, less than or equal to about 99.95% less than or equal to about 99.9%, less than or equal to about 99%, less than or equal to about 98%, less than or equal to about 95%, less than or equal to about 90%, less than or equal to about 80%, less than or equal to about 70%, less than or equal to about 60%, less than or equal to about 50%, less than or equal to about 40%, or less than or equal to about 30%. Combinations of the above-referenced ranges are possible (e.g., at least about 60% and less than or equal to about 99.99%). Other ranges are also possible.

In certain embodiments, the initial fluid separation efficiency may be at least about 20%, at least about 25%, at least about 30%, at least about 40%, at least about 50%, at least about 60%, at least about 70%, at least about 80%, at least about 90%, at least about 95%, at least about 98%, at least about 99%, at least about 99.9%, or at least about 99.99%. In some instances, the initial fluid separation efficiency may be less than or equal to about 99.99%, less than or equal to about 99.9%, less than or equal to about 99%, less than or equal to about 98%, or less than or equal to about 95%. Combinations of the above-referenced ranges are possible (e.g., at least about 60% and less than or equal to about 99.99%). Other ranges are also possible.

As used herein, average and initial fluid separation efficiency is measured using the SAEJ1488 test. The test involves sending a sample of fuel (ultra-low sulfur diesel fuel) with controlled water content (2500 ppm) through a pump across the media at a face velocity of 0.069 cm/sec. The water is emulsified into fine droplets and sent to challenge the media. The water is either coalesced, or shed or both, and collects at the bottom of the housing. The water content of the sample is measured both upstream and downstream of the media, via Karl Fischer titration. The efficiency is the amount of water removed from the fuel-water mixture. The fluid separation efficiency is calculated as (1−C/2500)*100, where C is the downstream concentration of water. The initial efficiency is calculated at the first 10 minutes of the test and the average efficiency is calculated as the average of the efficiency at the end of 150 minutes. To measure average fluid separation efficiency as described herein, the first measurement of the sample upstream and downstream of the media is taken at 10 minutes from the start of the test. Then, measurement of the sample downstream of the media is taken every 20 minutes.

In some embodiments, higher average and initial fluid separation efficiencies may be achieved by using multiple layers of media described herein by including multiple stages of filter media (e.g., multiple alternating hydrophobic and hydrophilic stages), and/or by controlling the pore size, basis weight, thickness, and/or surface chemistries of the layers and/or stages.

As noted above, in some embodiments, the first layer (e.g., layer including fine polymeric staple fibers) may be more hydrophobic than a second layer in the filter media. In some such embodiments, the water contact angle on the surface of the first layer (e.g., layer including fine polymeric staple fibers) may be greater than or equal to about 30 degrees and less than or equal to about 165 degrees (e.g., greater than or equal to about 35 degrees and less than or equal to about 165, or other ranges described herein). The water contact angle on the surface of the second layer may be greater than or equal to about 0 degrees and less than or equal to about 125 degrees (or other ranges described herein), provided that the water contact angle of the first layer (e.g., layer including fine polymeric staple fibers) is greater than the water contact angle of the second layer.

In general, the contact angle of the first layer (e.g., layer including fine polymeric staple fibers) may be selected as desired. In some embodiments, the water contact angle on the surface of the first layer (e.g., layer including fine polymeric staple fibers) may be greater than or equal to about 30 degrees, greater than or equal to about 35 degrees, greater than or equal to about 40 degrees, greater than or equal to about 50 degrees, greater than or equal to about 60 degrees, greater than or equal to about 70 degrees, greater than or equal to about 60 degrees, greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about 165 degrees, less than or equal to about 160 degrees, less than or equal to about 150 degrees, less than or equal to about 140 degrees, less than or equal to about 130 degrees, less than or equal to about 120 degrees, less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, or less than or equal to about 35 degrees. Combinations of the above-referenced ranges are also possible (e.g., greater than or equal to about 30 degrees and less than or equal to about 165 degrees). The water contact angle may be measured using standard ASTM D5946 (2009). The contact angle is the angle between the substrate surface and the tangent line drawn to the water droplet surface at the three-phase point, when a liquid drop is resting on the substrate surface. A contact angle meter or goniometer can be used for this determination.

In some embodiments, the water contact angle on the surface of the second layer is less than or equal to about 125 degrees, less than or equal to about 120 degrees, less than or equal to about 110 degrees, less than 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, less than or equal to about 30 degrees, less than or equal to about 25 degrees, less than or equal to about 20 degrees, or less than or equal to about 15 degrees. In some instances, the water contact angle is greater than or equal to about 0 degrees, greater than or equal to about 5 degrees, greater than or equal to about 10 degrees, greater than or equal to about 20 degrees, greater than or equal to about 30 degrees, greater than or equal to about 40 degrees, greater than or equal to about 50 degrees, greater than or equal to about 60 degrees, greater than or equal to about 70 degrees, greater than 80 degrees, greater than or equal to 90 degrees, greater than or equal to 100 degrees, greater than or equal to 110 degrees, greater than or equal to 115 degrees, or greater than or equal to 120 degrees. Combinations of the above-referenced ranges are also possible. In certain embodiments, a fiber (e.g., a polymeric staple fiber) present in a layer is formed of a material having a contact angle (e.g., a water contact angle) within one or more ranges. As used herein, a contact angle of a material is determined by measuring contact angle, according to standard ASTM D5946 (2009), on a flatsheet produced exclusively of fibers formed of the material, the fibers having an average fiber diameter of 0.8±0.5 microns, and the flatsheet having a basis weight of 50 g/m² and a MFP of 1.5-6.5 microns.

In some embodiments, the water contact angle of a material or a layer (e.g., a modified layer, an unmodified layer) described herein (e.g., the water contact angle of a material used to form polymeric staple fibers, such as a first and/or a second plurality of polymeric staple fibers) may be greater than or equal to about 30 degrees, greater than or equal to about 35 degrees, greater than or equal to about 40 degrees, greater than or equal to about 50 degrees, greater than or equal to about 60 degrees, greater than or equal to about 70 degrees, greater than or equal to about 80 degrees, greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about 165 degrees, less than or equal to about 160 degrees, less than or equal to about 150 degrees, less than or equal to about 140 degrees, less than or equal to about 130 degrees, less than or equal to about 120 degrees, less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, or less than or equal to about 35 degrees. Combinations of the above-referenced ranges are also possible (e.g., greater than or equal to about 30 degrees and less than or equal to about 165 degrees).

It should be understood that the contact angles, described herein, refer to modified and unmodified layers.

In certain embodiments, the polymeric staple fibers (a first and/or a second plurality of polymeric staple fibers) of a layer described herein (e.g., a first layer) are formed of a material having a greater hydrophobicity than a hydrophobicity of a second layer. In such embodiments, the water contact angle of the material used to form the polymeric staple fibers, as measured using a flatsheet of fibers formed of such a material as described above, is greater than the water contact angle as measured on a surface of the second layer.

In some embodiments described herein, a layer includes first plurality of polymeric staple fibers, which are formed of a material that is hydrophilic (e.g., the water contact angle of the material used to form the first polymeric staple fibers, as measured using a flatsheet of fibers formed of such a material as described above, is less than 90 degrees). In some embodiments, a layer includes a second plurality of polymeric staple fibers. In certain embodiments, the second plurality of polymeric staple fibers are formed of a material that is hydrophobic (e.g., the water contact angle of the material used to form the second plurality of polymeric staple fibers, as measured using a flatsheet of fibers formed of such a material as described above, is at least 90 degrees). In some embodiments, a layer includes a first plurality of polymeric staple fibers that are formed of a material that is less hydrophobic than a material used to form a second plurality of polymeric staple fibers (e.g., the water contact angle of the material used to form the first plurality of polymeric staple fibers, as measured using a flatsheet of fibers formed of such a material as described above, is less than a contact angle of the material used to form the second polymeric staple fibers, as measured using a flatsheet of fibers formed of such a material as described above). Other configurations are also possible.

It should also be understood that for the embodiments described above, a layer that intrinsically has the desired wetting characteristics with respect to a particular fluid and lacks a modification (e.g., surface modification) may be replaced with a modified layer. For instance, in certain embodiments, a layer having a modified surface as described herein (e.g., a first layer) may have a greater hydrophobicity than a hydrophobicity of a second layer.

In some embodiments, the entire filter media comprising the layer including fine polymeric staple fibers, which may have relatively high fluid separation efficiency, may also have a relatively high dust holding capacity. The dust holding capacity may be, for example, greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 300 g/m², greater than or equal to about 350 g/m², greater than or equal to about 400 g/m², or greater than or equal to about 450 g/m². In some instances, the dust holding capacity may be less than or equal to about 600 g/m², less than or equal to about 550 g/m², less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 10 g/m² and less than or equal to about 350 g/m², greater than or equal to about 20 g/m² and less than or equal to about 300 g/m²). Other values of DHC are possible. The dust holding capacity may be determined using ISO 19438.

In some embodiments, the specific dust holding capacity (dust holding capacity of a media/layer divided by the thickness of the media/layer) may be greater than or equal to about 50 g/m²/mm, greater than or equal to about 75 g/m²/mm, greater than or equal to about 90 g/m²/mm, greater than or equal to about 100 g/m²/mm, greater than or equal to about 200 g/m²/mm, greater than or equal to about 300 g/m²/mm, greater than or equal to about 500 g/m²/mm, greater than or equal to about 700 g/m²/mm, or greater than or equal to about 900 g/m²/mm. In some instances, the specific dust holding capacity may be less than or equal to about 1,000 g/m²/mm, less than or equal to about 900 g/m²/mm, less than or equal to about 800 g/m²/mm, less than or equal to about 700 g/m²/mm, less than or equal to about 600 g/m²/mm, less than or equal to about 500 g/m²/mm, less than or equal to about 400 g/m²/mm, less than or equal to about 300 g/m²/mm, or less than or equal to about 100 g/m²/mm. Combinations of the above-referenced ranges are possible (e.g., greater than or equal to about 50 g/m²/mm and less than or equal to about 1,000 g/m²/mm, greater than or equal to about 90 g/m²/mm and less than or equal to about 500 g/m²/mm). Other values of specific DHC are possible.

As described herein, in some embodiments, a layer may be hydrophilic. As used herein, the term “hydrophilic” refers to material that has a water contact angle of less than 90 degrees. Accordingly, a “hydrophilic layer” may refer to a layer that has a water contact angle of less than 90 degrees on the surface of the layer. In some embodiments, the layer may be hydrophilic such that the water contact angle is less than 90 degrees, less than or equal to about 80 degrees, less than or equal to about 75 degrees, less than or equal to about 70 degrees, less than or equal to about 65 degrees, less than or equal to about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, less than or equal to about 20 degrees, or less than or equal to about 15 degrees. In some embodiments, the water contact angle is greater than or equal to about 0 degrees, greater than or equal to about 5 degrees, greater than or equal to about 10 degrees, greater than or equal to about 15 degrees, greater than or equal to about 20 degrees, greater than or equal to about 25 degrees, greater than or equal to about 35 degrees, greater than or equal to about 45 degrees, or greater than or equal to about 60 degrees. Combinations of the above-referenced ranges are also possible (e.g., greater than or equal to about 0 degrees and less than 90 degrees, greater than or equal to about 0 degrees and less than about 60 degrees).

As described herein, in some embodiments, a layer may be hydrophobic. As used herein, the term “hydrophobic” refers to material that has a water contact angle of greater than or equal to 90 degrees (e.g., greater than or equal to 120 degrees, greater than or equal to 150 degrees). Accordingly, a “hydrophobic layer” may refer to a layer that has a water contact angle of greater than or equal to 90 degrees on the surface of the layer. In some embodiments, the surface may be modified to be hydrophobic such that the water contact angle is greater than or equal to 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some such embodiments, the surface may have a contact angle greater than or equal to about 150 degrees. In some instances, the water contact angle is less than or equal to about 180 degrees, less than or equal to about 175 degrees, less than or equal to about 165 degrees, less than or equal to about 150 degrees, less than or equal to about 135 degrees, less than or equal to about 120 degrees, or less than or equal to about 105 degrees. Combinations of the above-referenced ranges are also possible (e.g., greater than or equal to 90 degrees and less than about 180 degrees, greater than or equal to about 105 degrees and less than about 180 degrees).

In some embodiments, the layer including fine polymeric staple fibers may be used to impart a relatively high initial and/or average particulate efficiency to the overall filter media. For instance, in some embodiments, the initial efficiency of the overall filter media may be greater than or equal to about 50%, greater than or equal to about 60%, greater than or equal to about 70%, greater than or equal to about 80%, greater than or equal to about 90%, greater than or equal to about 95%, greater than or equal to about 96%, greater than or equal to about 97%, greater than or equal to about 98%, greater than or equal to about 99%, or greater than or equal to about 99.9%, greater than or equal to about 99.99%, or about 100%. In some instances, the initial efficiency of the overall filter media may be less than or equal to about 100%, less than or equal to about 99.99%, less than or equal to about 98%, less than or equal to about 97%, less than or equal to about 96%, less than or equal to about 90%, less than or equal to about 80%, less than or equal to about 70%, or less than or equal to about 60%. Combinations of the above-referenced ranges are also possible (e.g., greater than or equal to about 50% and less than or equal to about 99.99%, greater than or equal to about 60% and less than or equal to about 99.99%). Other values of the initial efficiency of the filter media are also possible. The initial efficiency may be determined according to standard ISO 19438 (2013). As described herein, initial efficiency can be measured at different particle sizes (e.g., for x micron or greater particles, where x is described herein), and the above ranges of initial efficiency may be suitable for the various particle sizes described herein. In some embodiments, x is 4 microns such that the above ranges of initial efficiency are suitable for filtering out 4 micron or larger particles.

In some embodiments, the average efficiency of the overall filter media may be greater than or equal to about 60%, greater than or equal to about 70%, greater than or equal to about 80%, greater than or equal to about 90%, greater than or equal to about 95%, greater than or equal to about 96%, greater than or equal to about 97%, greater than or equal to about 98%, greater than or equal to about 99%, greater than or equal to about 99.9%, greater than or equal to about 99.99%, or about 100%. In some instances, the average efficiency of the overall filter media may be less than or equal to about 100%, less than or equal to about 99.99%, less than or equal to about 98%, less than or equal to about 97%, less than or equal to about 96%, less than or equal to about 90%, less than or equal to about 80%, or less than or equal to about 70%. Combinations of the above-referenced ranges are also possible (e.g., greater than or equal to about 60% and less than or equal to about 100%, greater than or equal to about 70% and less than or equal to about 100%). Other values of the average efficiency of the filter media are also possible.

The filter media described herein may be used for the filtration of various particle sizes. The efficiency of the filter media for capturing particles having a particle size, x (microns) or greater can be measured. In a typical test for measuring efficiency of a layer or the entire media (e.g., according to the standard ISO 19438 (2013)), particle counts at the particle size, x, selected (e.g., where x is 1, 3, 4, 5, 7, 10, 15, 20, 25, or 30 microns) upstream and downstream of the layer or media can be taken at ten points equally divided over the time of the test. Generally, a particle size of x means that x micron or greater particles will be captured by the layer or media. The average of upstream and downstream particle counts can be taken at the selected particle size. From the average particle count upstream (injected −C₀) and the average particle count downstream (passed thru −C) the filtration efficiency test value for the particle size selected can be determined by the relationship [(1−[C/C₀])*100%].

As described herein, efficiency can be measured according to standard ISO 19438 (2013). The testing uses ISO12103-3 medium grade test dust at a base upstream gravimetric dust level (BUGL) of 50 mg/liter. The test fluid is Aviation Hydraulic Fluid AERO HFA MIL H-5606A manufactured by Mobil. The test is run at a face velocity of 0.06 cm/s until a terminal pressure of 100 kPa. Unless otherwise stated, the dust holding capacity values and/or average efficiency values described herein are determined at a terminal pressure of 100 kPa. The average efficiency is the average of the efficiency values measured at one minute intervals until the terminal pressure is reached. A similar protocol can be used for measuring initial efficiency, which refers to the average efficiency measurements of the media at 4, 5, and 6 minutes after running the test. Unless otherwise indicated, average efficiency and initial efficiency measurements described herein refer to values where x=4 microns.

In some embodiments, the overall filter media comprising the layer including fine polymeric staple fibers may have a dust holding capacity of greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 300 g/m², greater than or equal to about 350 g/m², greater than or equal to about 400 g/m², or greater than or equal to about 450 g/m². In some instances, the dust holding capacity may be less than or equal to about 600 g/m², less than or equal to about 550 g/m², less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 10 g/m² and less than or equal to about 500 g/m², greater than or equal to about 50 g/m² and less than or equal to about 300 g/m²). Other values of DHC are possible. The dust holding capacity may be determined using ISO 19438.

In some embodiments, the layer including fine polymeric staple fibers may be used to impart a relatively high particulate efficiency and a relatively high fluid separation efficiency to an overall filter media. In some such embodiments, the filter media comprises a layer including fine polymeric staple fibers having a specific wettability with respect to the fluid to be separated and a second layer. For instance, the layer including fine polymeric staple fibers may comprise a blend of two or more different fine polymeric staple fibers that may be used to impart the desired wettability to the layer. For example, the layer including fine polymeric staple fibers may comprise a hydrophobic fine polymeric staple fiber and a hydrophilic polymeric staple fiber. The combination of hydrophobic and hydrophilic fibers may produce a layer including fine polymeric staple fibers with intermediate wetting properties compared to fiber layers formed of the respective fibers alone.

In embodiments in which the layer including fine polymeric staple fibers comprises hydrophobic and hydrophilic fibers, the weight percentage of hydrophobic and hydrophilic fibers may be selected to achieve the desired wettability. For instance, in some embodiments, the weight percentage of hydrophobic fine polymeric staple fibers in the layer may be greater than or equal to about 10%, greater than or equal to about 25%, greater than or equal to about 30%, greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, greater than or equal to about 75%, greater than or equal to about 80%, greater than or equal to about 85%, or greater than or equal to about 90% by weight, e.g., based on the total weight of fibers in a layer. In some instances, the weight percentage of the hydrophobic fine polymeric staple fibers in the layer may be less than or equal to about 75%, less than or equal to about 70%, less than or equal to about 65%, less than or equal to about 60%, less than or equal to about 55%, less than or equal to about 50%, less than or equal to about 45%, less than or equal to about 40%, less than or equal to about 35%, or less than or equal to about 30% by weight, based on the total weight of fibers in a layer. Combinations of the above-referenced ranges are possible (e.g., greater than or equal to about 25% and less than or equal to about 100%). In some embodiments, the weight percentage of hydrophobic fine polymeric staple fibers in the layer is 100%. In some embodiments, the above weight percentages are based on the weight of the total dry solids of the layer (including any resins).

In some embodiments, the weight percentage of hydrophilic fine polymeric staple fibers in the layer may be greater than or equal to about 0%, greater than or equal to about 5%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 75%, or greater than or equal to about 90% by weight, e.g., based on the total weight of fibers in a layer. In some instances, the weight percentage of hydrophilic fine polymeric staple fibers in the layer may be less than or equal to about 90%, less than or equal to about 75%, less than or equal to about 70%, less than or equal to about 65%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, or less than or equal to about 5% by weight, based on the total weight of fibers in a layer. Combinations of the above-referenced ranges are possible (e.g., greater than or equal to about 0% and less than or equal to about 90%). In some embodiments, the above weight percentages are based on the weight of the total dry solids of the layer (including any resins).

In some embodiments, the filter media comprising the layer including fine polymeric staple fibers that is designed to impart both high fluid separation and high particulate efficiency, may have an overall average fluid separation efficiency of the filter media ranging from about 30% to about 99.99% or higher (e.g., between about 40% to about 99.99%, between about 50% to about 99.99%, between about 60% to about 99.99%). For instance, in certain embodiments, the average fluid separation efficiency of the filter media may be at least about 30%, at least about 40%, at least about 50%, at least about 60%, at least about 70%, at least about 80%, at least about 90%, at least about 95%, at least about 98%, at least about 99%, or at least about 99.5%. In some instances, the average fluid separation efficiency of the filter media may be less than or equal to about 99.99%, less than or equal to about 99.95% less than or equal to about 99.9%, less than or equal to about 99%, less than or equal to about 98%, less than or equal to about 95%, less than or equal to about 90%, less than or equal to about 80%, less than or equal to about 70%, less than or equal to about 60%, less than or equal to about 50%, or less than or equal to about 40%. Combinations of the above-referenced ranges are possible. Other ranges are also possible.

In some embodiments, the filter media including the layer including fine polymeric staple fibers that is designed to impart both high fluid separation and particulate efficiency may have an initial particulate efficiency (e.g., where x=4 microns) of greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, or greater than or equal to about 99.9%. In some instances, the initial particulate efficiency of the filter media may be less than or equal to about 100%, less than or equal to about 99.99%, less than or equal to about 99%, less than or equal to about 98%, less than or equal to about 97%, less than or equal to about 95%, less than or equal to about 90%, or less than or equal to about 85%. Combinations of the above-referenced ranges are also possible (e.g., greater than or equal to about 80% and less than or equal to about 100%, greater than or equal to about 90% and less than or equal to about 100%). Other values of the initial efficiency of the filter media are also possible.

In some embodiments, the average particulate efficiency of the filter media (e.g., where x=4 microns) may be greater than or equal to about 85%, greater than or equal to about 90%, greater than or equal to about 95%, greater than or equal to about 96%, greater than or equal to about 97%, greater than or equal to about 98%, greater than or equal to about 99%, or greater than or equal to about 99.9%. In some instances, the average particulate efficiency of the filter media may be less than or equal to about 100%, less than or equal to about 99.99%, less than or equal to about 99%, less than or equal to about 98%, less than or equal to about 97%, less than or equal to about 95%, or less than or equal to about 90%. Combinations of the above-referenced ranges are also possible (e.g., greater than or equal to about 85% and less than or equal to about 100%, greater than or equal to about 90% and less than or equal to about 100%). Other values of the average particulate efficiency of the filter media are also possible.

In some embodiments, the thickness of the entire filter media may be greater than or equal to about 0.03 mm, greater than or equal to about 0.05 mm, greater than or equal to about 0.1 mm, greater than or equal to about 0.2 mm, greater than or equal to about 0.5 mm, greater than or equal to about 1 mm, greater than or equal to about 5 mm, greater than or equal to about 10 mm, greater than or equal to about 15 mm, greater than or equal to about 20 mm, or greater than or equal to about 25 mm. In some instances, the thickness of the filter media may be less than or equal to about 30 mm, less than or equal to about 25 mm, less than about 20 mm, less than or equal to about 15 mm, less than or equal to about 10 mm, less than or equal to about 5 mm, less than or equal to about 1 mm, or less than or equal to about 0.5 mm. All combinations of the above-referenced ranges are possible (e.g., greater than or equal to about 0.03 mm and less than or equal to about 30 mm, greater than or equal to about 0.05 mm and less than or equal to about 20 mm). Other values of thickness of the filter media are possible. The thickness of the entire filter media may be determined according to the standard ISO 534 (2011) at 2N/cm².

The filter media may have an improved lifetime relative to certain conventional filter media. The lifetime, as referred to herein, is measured according to the standard ISO 4020 (2001). The testing can be performed using mineral oil, 4-6 cST at 23° C. as the test fluid. The test fluid contains a mixture of carbon black and Mira 2 aluminum oxide as the organic and inorganic contaminants, respectively. The flow rate of the test fluid is 36.7 Lpm/m2 and the terminal differential pressure is a 70 kPa rise over the clean filter media. The test fixture has a 90 mm diameter. The inorganic contaminant is 20 grams of Mira 2 aluminum oxide per 20 liters of mineral oil, 4-6 cST, and the organic contaminant is 1.25 grams of carbon black per 20 liters of mineral oil, 4-6 cST. The lifetime is determined to be the time, in minutes, required to reach a terminal differential pressure of 70 kPa over the clean filter media with no contaminants.

In some embodiments, the filter media may have an average lifetime of greater than or equal to about 3 minutes, greater than or equal to about 6 minutes, greater than or equal to about 10 minutes, greater than or equal to about 20 minutes, greater than or equal to about 40 minutes, greater than or equal to about 55 minutes, greater than or equal to about 60 minutes, greater than or equal to about 70 minutes, greater than or equal to about 85 minutes, greater than or equal to about 100 minutes, greater than or equal to about 125 minutes, greater than or equal to about 150 minutes, greater than or equal to about 175 minutes, greater than or equal to about 200 minutes, or greater than or equal to about 225 minutes. In some instances, the filter media may have an average lifetime of less than or equal to about 250 minutes, less than or equal to about 225 minutes, less than or equal to about 200 minutes, less than or equal to about 175 minutes, less than or equal to about 160 minutes, less than or equal to about 130 minutes, less than or equal to about 110 minutes, less than or equal to about 85 minutes, less than or equal to about 65 minutes, less than or equal to about 50 minutes, or less than or equal to about 25 minutes. Combinations of the above-referenced ranges are also possible (e.g., greater than or equal to about 3 minutes and less than or equal to about 200 minutes, greater than or equal to about 6 minutes and less than or equal to about 250 minutes). In some embodiments, a filter media comprising a first layer, a second layer, and a third layer may have a relatively high lifetime (e.g., greater than or equal to about 6 minutes and less than or equal to about 250 minutes). Other values of average lifetime are also possible. The lifetime may be determined according to the standard ISO 4020.

In some embodiments, the entire filter media may have a basis weight of greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 300 g/m², greater than or equal to about 400 g/m², greater than or equal to about 500 g/m², greater than or equal to about 600 g/m², greater than or equal to about 700 g/m², greater than or equal to about 800 g/m², or greater than or equal to about 900 g/m². In some instances, the filter media may have a basis weight of less than or equal to about 1,000 g/m², less than or equal to about 900 g/m², less than or equal to about 800 g/m², less than or equal to about 700 g/m², less than or equal to about 600 g/m², less than or equal to about 500 g/m², less than or equal to about 400 g/m², less than or equal to about 300 g/m², less than or equal to about 200 g/m², less than or equal to about 150 g/m², less than or equal to about 100 g/m², less than or equal to about 50 g/m², or less than or equal to about 25 g/m². Combinations of the above-referenced ranges are possible (e.g., greater than or equal to about 5 g/m² and less than or equal to about 1,000 g/m², greater than or equal to about 10 g/m² and less than or equal to about 800 g/m²). Other values of basis weight are possible. The basis weight may be determined according to the standard ISO 536 (2012).

In some embodiments, the filter media described herein may have a relatively high strength. For instance, in some embodiments, the entire filter may have a dry Mullen Burst strength of greater than or equal to about 0.5 psi, greater than or equal to about 1 psi, greater than or equal to about 2 psi, greater than or equal to about 5 psi, greater than or equal to about 10 psi, greater than or equal to about 25 psi, greater than or equal to about 50 psi, greater than or equal to about 75 psi, greater than or equal to about 100 psi, greater than or equal to about 125 psi, greater than or equal to about 150 psi, or greater than or equal to about 175 psi. In some instances, the dry Mullen Burst strength may be less than or equal to about 200 psi, less than or equal to about 175 psi, less than or equal to about 150 psi, less than or equal to about 125 psi, less than or equal to about 100 psi, less than or equal to about 75 psi, less than or equal to about 50 psi, less than or equal to about 25 psi, or less than or equal to about 10 psi. Combinations of the above-referenced ranges are also possible (e.g., greater than or equal to about 1 psi and less than or equal to about 200 psi, greater than or equal to about 2 psi and less than or equal to about 175 psi). Other values of dry Mullen Burst strength are also possible. The dry Mullen Burst strength may be determined according to the standard T403 om-97 (1997).

In some embodiments, the entire filter media may have a dry tensile elongation in the cross direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the cross direction may be less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 20%, greater than or equal to about 2% and less than or equal to about 13%). Other values of dry tensile elongation in the cross direction are also possible. The dry tensile elongation in the cross direction may be determined according to the standard T494 om-96 (1996) using a test span of 4 in and a jaw separation speed of 12 in/min.

In some embodiments, the entire filter media may have a dry tensile elongation in the machine direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the machine direction may be less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 20%, greater than or equal to about 2% and less than or equal to about 13%). Other values of dry tensile elongation in the machine direction are also possible. The dry tensile elongation in the machine direction may be determined according to the standard T494 om-96 (1996) using a test span of 4 in and a jaw separation speed of 12 in/min.

In some embodiments, the entire filter media may have a dry tensile strength in the cross direction of greater than or equal to about 1 lb/in, greater than or equal to about 2 lb/in, greater than or equal to about 5 lb/in, greater than or equal to about 10 lb/in, greater than or equal to about 25 lb/in, greater than or equal to about 50 lb/in, greater than or equal to about 75 lb/in, greater than or equal to about 100 lb/in, or greater than or equal to about 125 lb/in. In some instances, the dry tensile strength in the cross direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, less than or equal to about 30 lb/in, or less than or equal to about 15 lb/in. Combinations of the above-referenced ranges are also possible (e.g., greater than or equal to about 1 lb/in and less than or equal to about 150 lb/in, greater than or equal to about 2 lb/in and less than or equal to about 125 lb/in). Other values of dry tensile strength in the machine direction are also possible. The dry tensile strength in the machine direction may be determined according to the standard T494 om-96 (1996) using a jaw separation speed of 1 in/min.

In some embodiments, the entire filter media may have a dry tensile strength in the machine direction of greater than or equal to about 1 lb/in, greater than or equal to about 2 lb/in, greater than or equal to about 5 lb/in, greater than or equal to about 10 lb/in, greater than or equal to about 25 lb/in, greater than or equal to about 50 lb/in, greater than or equal to about 75 lb/in, greater than or equal to about 100 lb/in, greater than or equal to about 125 lb/in, greater than or equal to about 150 lb/in, or greater than or equal to about 175 lb/in. In some instances, the dry tensile strength in the machine direction may be less than or equal to about 200 lb/in, less than or equal to about 175 lb/in, less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, less than or equal to about 30 lb/in, or less than or equal to about 15 lb/in. Combinations of the above-referenced ranges are also possible (e.g., greater than or equal to about 1 lb/in and less than or equal to about 200 lb/in, greater than or equal to about 2 lb/in and less than or equal to about 150 lb/in). Other values of dry tensile strength in the machine direction are also possible. The dry tensile strength in the machine direction may be determined according to the standard T494 om-96 (1996) using a jaw separation speed of 1 in/min.

In some embodiments, the entire filter may exhibit an advantageous air permeability. In some embodiments, the entire filter media may have an air permeability of greater than or equal to about 0.3 CFM, greater than or equal to about 0.4 CFM, greater than or equal to about 1 CFM, greater than or equal to about 5 CFM, greater than or equal to about 10 CFM, greater than or equal to about 25 CFM, greater than or equal to about 50 CFM, greater than or equal to about 75 CFM, greater than or equal to about 100 CFM, greater than or equal to about 125 CFM, greater than or equal to about 150 CFM, greater than or equal to about 175 CFM, greater than or equal to about 200 CFM, greater than or equal to about 225 CFM, greater than or equal to about 250 CFM, or greater than or equal to about 275 CFM. In some instances, the entire filter media may have an air permeability of less than or equal to about 300 CFM, less than or equal to about 275 CFM, less than or equal to about 250 CFM, less than or equal to about 225 CFM, less than or equal to about 200 CFM, less than or equal to about 175 CFM, less than or equal to about 150 CFM, less than or equal to about 125 CFM, less than or equal to about 100 CFM, less than or equal to about 75 CFM, less than or equal to about 50 CFM, or less than or equal to about 25 CFM. Combinations of the above-referenced ranges are also possible (e.g., greater than or equal to about 1 CFM and less than or equal to about 300 CFM, greater than or equal to about 1 CFM and less than or equal to about 250 CFM, greater than or equal to about 0.3 CFM and less than or equal to about 300 CFM, greater than or equal to about 0.3 CFM and less than or equal to about 250 CFM). Other values of air permeability are also possible. The air permeability may be determined using TAPPI T-251.

In some embodiments, the pressure drop across the entire filter media may be relatively low. For instance, in some embodiments, the pressure drop across the entire filter media may less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 5 kPa, less than or equal to about 1 kPa, or less than or equal to about 0.5 kPa. In some instances, the entire filter media may have a pressure drop of greater than or equal to about 0.01 kPa, greater than or equal to about 0.02 kPa, greater than or equal to about 0.05 kPa, greater than or equal to about 0.1 kPa, greater than or equal to about 0.5 kPa, greater than or equal to 1 kPa, greater than or equal to about 5 kPa, greater than or equal to about 10 kPa, greater than or equal to about 20 kPa, greater than or equal to about 30 kPa, greater than or equal to about 40 kPa, greater than or equal to about 50 kPa, greater than or equal to about 60 kPa, or greater than or equal to about 70 kPa. Combinations of the above-referenced ranges are also possible (e.g., greater than or equal to about 0.05 kPa and less than or equal to about 80 kPa, greater than or equal to about 0.1 kPa and less than or equal to about 50 kPa, greater than or equal to about 0.05 kPa and less than or equal to about 50 kPa, greater than or equal to about 0.01 kPa and less than or equal to about 80 kPa). Other values of pressure drop are also possible. The flatsheet pressure drop was measured using the ISO 3968 protocol (i.e. Hydraulic fluid power—Filters—Evaluation of differential pressure versus flow characteristics protocol). The pressure drop value was measured when clean hydraulic fluid at 15 cSt with a face velocity of 0.67 cm/s was passed through the filter media.

In one particular set of embodiments, a filter media is designed to impart both high particulate and fluid separation efficiency. In some embodiments, the media includes a first layer comprising a first plurality of polymeric staple fibers having an average diameter of less than or equal to about 1 micron and a second plurality of polymeric staple fibers having an average diameter of less than or equal to 1 micron. In certain embodiments, the first and second plurality of polymeric staples fibers are different. In some instances, the first layer has a water contact angle between about 30 degrees and 165 degrees. The media may include a second layer comprising fibers having an average diameter of greater than or equal to about 4 microns. In some embodiments, the filter media has an air permeability between 0.3 CFM and 300 CFM and a basis weight of between 5 g/m² and 1,000 g/m². Additionally or alternatively, in some embodiments, the filter media may have a dust holding capacity of greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 300 g/m², greater than or equal to about 350 g/m², greater than or equal to about 400 g/m², or greater than or equal to about 450 g/m². In some instances, the dust holding capacity may be less than or equal to about 600 g/m², less than or equal to about 550 g/m², less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 10 g/m² and less than or equal to about 600 g/m², greater than or equal to about 50 g/m² and less than or equal to about 300 g/m²). Other values of DHC are possible. The dust holding capacity may be determined using ISO 19438.

In general, one or more layers (e.g., a first layer, a second layer, a third layer) may comprise any suitable fibers. For instance, in some embodiments, a layer (e.g., a second layer, a third layer) in the filter media may include synthetic fibers. Synthetic fibers may include any suitable type of synthetic polymer. Examples of suitable synthetic fibers include staple fibers, polyesters (e.g., polyethylene terephthalate, polybutylene terephthalate), polycarbonate, polyamides (e.g., various nylon polymers), polyaramid, polyimide, polyethylene, polypropylene, polyether ketone, polyolefin, polyacrylics, polyvinyl alcohol, regenerated cellulose (e.g., synthetic cellulose such lyocell, rayon, acrylic), polyacrylonitriles, polysulfones, polyvinylidene fluoride (PVDF), copolymers of polyethylene and PVDF, copolymers of polypropylene and PVDF, polyphenylene ether sulfones, polyether sulfones, and combinations thereof. In some embodiments, the synthetic fibers are organic polymer fibers. Synthetic fibers may also include multi-component fibers (i.e., fibers having multiple compositions such as bicomponent fibers) and binder fibers. In some embodiments, the synthetic fibers are in the form of continuous fibers. In other embodiments, the synthetic fibers are in the form of staple fibers having an average fiber diameter that is larger than an average fiber diameter of the fine polymeric staple fibers described herein. The layer may also include combinations of more than one type of synthetic fiber. It should be understood that other types of synthetic fiber types may also be used. In certain embodiments, the fiber types described above may apply to the synthetic fibers of the overall media (e.g., the overall media may comprise one or more of the synthetic fibers described above).

In some embodiments, the average diameter of the synthetic fibers of one or more layers (e.g., a first layer, a second layer, a third layer) may be, for example, greater than or equal to about 0.1 microns, greater than or equal to about 0.3 microns, greater than or equal to about 0.5 microns, greater than or equal to about 1 micron, greater than or equal to about 2 microns, greater than or equal to about 3 microns, greater than or equal to about 4 microns, greater than or equal to about 5 microns, greater than or equal to about 8 microns, greater than or equal to about 10 microns, greater than or equal to about 12 microns, greater than or equal to about 15 microns, or greater than or equal to about 20 microns. In some instances, the synthetic fibers may have an average diameter of less than or equal to about 30 microns, less than or equal to about 20 microns, less than or equal to about 15 microns, less than or equal to about 10 microns, less than or equal to about 7 microns, less than or equal to about 5 microns, less than or equal to about 4 microns, less than or equal to about 1.5 microns, less than or equal to about 1 micron, less than or equal to about 0.8 microns, or less than or equal to about 0.5 microns. Combinations of the above-referenced ranges are also possible (e.g., greater than or equal to about 1 micron and less than or equal to about 5 microns). Other values of average fiber diameter are also possible. In certain embodiments, the ranges of average fiber diameter described above may apply to the synthetic fibers of the overall media (e.g., the overall media may comprise synthetic fibers having an average fiber diameter in one or more of the ranges described above).

In some cases, the synthetic fibers may be continuous (e.g., meltblown fibers, meltspun fibers, spunbond fibers, electrospun fibers, centrifugal spun fibers, etc.). For instance, synthetic fibers may have an average length of greater than or equal to about 1 inch, greater than or equal to about 50 inches, greater than or equal to about 100 inches, greater than or equal to about 300 inches, greater than or equal to about 500 inches, greater than or equal to about 700 inches, or greater than or equal to about 900 inches. In some instances, synthetic fibers may have an average length of less than or equal to about 1000 inches, less than or equal to about 800 inches, less than or equal to about 600 inches, less than or equal to about 400 inches, or less than or equal to about 100 inches. Combinations of the above-referenced ranges are also possible (e.g., greater than or equal to about 50 inches and less than or equal to about 1000 inches). Other values of average fiber length are also possible.

In other embodiments, the synthetic fibers are not continuous (e.g., staple fibers). For instance, in some embodiments, synthetic fibers in one or more layers in the filter media may have an average length of greater than or equal to about 0.025 mm, greater than or equal to about 0.05 mm, greater than or equal to about 0.5 mm, greater than or equal to about 1 mm, greater than or equal to about 2 mm, greater than or equal to about 4 mm, greater than or equal to about 6 mm, greater than or equal to about 8 mm, greater than or equal to about 10 mm, greater than or equal to about 12 mm, or greater than or equal to about 15 mm. In some instances, synthetic fibers may have an average length of less than or equal to about 25 mm, less than or equal to about 20 mm, less than or equal to about 15 mm, less than or equal to about 12 mm, less than or equal to about 10 mm, less than or equal to about 8 mm, less than or equal to about 6 mm, less than or equal to about 4 mm, less than or equal to about 2 mm, less than or equal to about 1 mm, or less than or equal to about 0.5 mm. Combinations of the above-referenced ranges are also possible (e.g., greater than or equal to about 1 mm and less than or equal to about 4 mm). Other values of average fiber length are also possible. In certain embodiments, the ranges of average fiber length described above may apply to the synthetic fibers of the overall media.

In some embodiments, the weight percentage of synthetic fibers in one or more layers (e.g., a first layer, a second layer, a third layer) may be relatively high. For instance, in some embodiments, the weight percentage of synthetic fibers in one or more layers may be greater than or equal to about 0.5 wt %, greater than or equal to about 1 wt %, greater than or equal to about 2 wt %, greater than or equal to about 20 wt %, greater than or equal to about 40 wt %, greater than or equal to about 60 wt %, greater than or equal to about 80 wt %, greater than or equal to about 90 wt %, or greater than or equal to about 95 wt %. In some instances, the weight percentage of synthetic fibers in one or more layers and/or the entire filter media may be less than or equal to about 100 wt %, less than or equal to about 98 wt %, less than or equal to about 85 wt %, less than or equal to about 75 wt %, less than or equal to about 50 wt %, less than or equal to about 25 wt %, less than or equal to about 10 wt %, or less than or equal to about 5 wt %. Combinations of the above-referenced ranges are also possible (e.g., greater than or equal to about 2 wt % and less than or equal to about 100 wt %). Other values of weight percentage of synthetic fibers in one or more and/or the entire filter media are also possible. In some embodiments, the layer includes 100 wt % synthetic fibers. In some embodiments, a layer of the filter media includes the above-noted ranges of synthetic fibers with respect to the total amount of fibers in the layer or the filter media, respectively. In certain embodiments, the ranges described above may apply to the synthetic fibers of the overall media.

In some embodiments, one or more layers (e.g., layer including fine polymeric staple fibers, second layer) and/or the entire filter media may include binder fibers. The binder fibers typically comprise a small weight percentage of one or more layers and/or the entire filter media. For example, the binder fibers may comprise less than about 10%, or less than about 5% (e.g., between 2% and 5%) of the weight percentage of total fibers in the layer or entire filter media.

In some embodiments, one or more layers (e.g., layer including fine polymeric staple fibers, second layer) and/or the entire filter media in the filter media may include one or more cellulose fibers, such as softwood fibers, hardwood fibers, a mixture of hardwood and softwood fibers, regenerated cellulose fibers (e.g., rayon, fibrillated synthetic cellulose fibers such as Lyocell fibers), microfibrillated cellulose, and mechanical pulp fibers (e.g., groundwood, chemically treated mechanical pulps, and thermomechanical pulps). Exemplary softwood fibers include fibers obtained from mercerized southern pine (e.g., mercerized southern pine fibers or “HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga. Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

The average diameter of the cellulose fibers in one or more layers (e.g., layer including fine polymeric staple fibers, second layer) and/or the entire filter media may be, for example, greater than or equal to about 1 micron, greater than or equal to about 2 microns, greater than or equal to about 3 microns, greater than or equal to about 4 microns, greater than or equal to about 5 microns, greater than or equal to about 8 microns, greater than or equal to about 10 microns, greater than or equal to about 15 microns, greater than or equal to about 20 microns, greater than or equal to about 30 microns, or greater than or equal to about 40 microns. In some instances, the cellulose fibers may have an average diameter of less than or equal to about 50 microns, less than or equal to about 40 microns, less than or equal to about 30 microns, less than or equal to about 20 microns, less than or equal to about 15 microns, less than or equal to about 10 microns, less than or equal to about 7 microns, less than or equal to about 5 microns, less than or equal to about 4 microns, or less than or equal to about 2 microns. Combinations of the above-referenced ranges are also possible (e.g., greater than or equal to about 1 micron and less than or equal to about 5 microns). Other values of average fiber diameter are also possible.

In some embodiments, the cellulose fibers may have an average length. For instance, in some embodiments, cellulose fibers may have an average length of greater than or equal to about 0.5 mm, greater than or equal to about 1 mm, greater than or equal to about 2 mm, greater than or equal to about 3 mm, greater than or equal to about 4 mm, greater than or equal to about 5 mm, greater than or equal to about 6 mm, or greater than or equal to about 8 mm. In some instances, cellulose fibers may have an average length of less than or equal to about 10 mm, less than or equal to about 8 mm, less than or equal to about 6 mm, less than or equal to about 4 mm, less than or equal to about 2 mm, or less than or equal to about 1 mm. Combinations of the above-referenced ranges are also possible (e.g., greater than or equal to about 1 mm and less than or equal to about 3 mm). Other values of average fiber length are also possible.

Regardless of the type of cellulose fibers, in some embodiments, the weight percentage of cellulose fibers in one or more layers (e.g., layer including fine polymeric staple fibers, second layer) and/or the entire filter media may be greater than or equal to about 0 wt %, greater than or equal to about 5 wt %, greater than or equal to about 10 wt %, greater than or equal to about 15 wt %, greater than or equal to about 45 wt %, greater than or equal to about 65 wt %, or greater than or equal to about 90 wt %, e.g., based on the total weight of fibers in the layer or media. In some instances, the weight percentage of the cellulose fibers in one or more layers and/or the entire filter media may be less than or equal to about 100 wt %, less than or equal to about 85 wt %, less than or equal to about 55 wt %, less than or equal to about 20 wt %, less than or equal to about 10 wt %, or less than or equal to about 2 wt %, e.g., based on the total weight of fibers in the layer or media. Combinations of the above-referenced ranges are also possible (e.g., greater than or equal to about 0 wt % and less than or equal to about 100 wt %). Other values of weight percentage of the cellulose fibers in one or more layers are also possible. In some embodiments, one or more layers (e.g., second layer) and/or the entire filter media include 100 wt % cellulose fibers. In other embodiments, one or more layers (e.g., layer including fine polymeric staple fibers) and/or the entire filter media include 0 wt % cellulose fibers. In some embodiments, a layer or media includes the above-noted ranges of cellulose fibers with respect to the total weight of fibers in the layer or media, respectively. In some embodiments, the above weight percentages are based on the weight of the total dry solids of the layer (including any resins).

In embodiments in which fibrillated fibers (e.g., fibrillated regenerated cellulose (e.g., rayon, Lyocell), microfibrillated cellulose, nanofibrillated cellulose, fibrillated synthetic fibers, including nanofibrillated synthetic fibers (e.g., fibrillated fibers formed of synthetic polymers such as polyester, polyamide, polyaramid, para-aramid, meta-aramid, polyimide, polyethylene, polypropylene, polyether ether ketone, polyethylene terephthalate, polyolefin, nylon, and/or acrylics), fibrillated natural fibers (e.g., hardwood, softwood)) are included in a layer, regardless of the type of fibrillated fibers, the weight percentage of fibrillated fibers in one or more layers (e.g., layer including fine polymeric staple fibers, second layer) and/or the entire filter media may be greater than or equal to about 0 wt %, greater than or equal to about 1 wt %, greater than or equal to about 5 wt %, greater than or equal to about 10 wt %, greater than or equal to about 20 wt %, greater than or equal to about 30 wt %, greater than or equal to about 40 wt %, greater than or equal to about 50 wt %, greater than or equal to about 60 wt %, greater than or equal to about 70 wt %, or greater than or equal to about 80 wt %, e.g., based on the total weight of fibers in the layer or media. In some instances, the weight percentage of the fibrillated fibers in one or more layers and/or the entire filter media may be less than or equal to about 98 wt %, less than or equal to about 95 wt %, less than or equal to about 90 wt %, less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10%, e.g., based on the total weight of fibers in the layer or media. Combinations of the above-referenced ranges are also possible (e.g., greater than or equal to about 0 wt %, and less than or equal to about 98 wt %, greater than or equal to about 0 wt %, and less than or equal to about 80 wt %). Other values of weight percentage of the fibrillated fibers in one or more layers and/or the entire filter media are also possible. In some embodiments, a layer or the filter media may include 0 wt % fibrillated fibers. In some embodiments, a layer or the filter media includes the above-noted ranges of fibrillated fibers with respect to the total weight of fibers in the layer or filter media, respectively. In some embodiments, the above weight percentages are based on the weight of the total dry solids of the layer (including any resins).

As known to those of ordinary skill in the art, a fibrillated fiber includes a parent fiber that branches into smaller diameter fibrils, which can, in some instances, branch further out into even smaller diameter fibrils with further branching also being possible. The branched nature of the fibrils leads to a high surface area and can increase the number of contact points between the fibrillated fibers and the fibers in the fiber web. Such an increase in points of contact between the fibrillated fibers and other fibers and/or components of the web may contribute to enhancing mechanical properties (e.g., flexibility, strength) and/or filtration performance properties of the fiber web.

In some embodiments the parent fibers may have an average diameter in the micron range. For example, the parent fibers may have an average diameter of greater than or equal to about 1 micron, greater than or equal to about 5 microns, greater than or equal to about 10 microns, greater than or equal to about 20 microns, greater than or equal to about 30 microns, greater than or equal to about 40 microns, greater than or equal to about 50 microns, greater than or equal to about 60 microns, or greater than or equal to about 70 microns. In some embodiments, the parent fibers may have an average diameter of less than or equal to about 75 microns, less than or equal to about 55 microns, less than or equal to about 35 microns, less than or equal to about 25 microns, less than or equal to about 15 microns, less than or equal to about 10 microns, or less than or equal to about 5 microns. Combinations of the above referenced ranges are also possible (e.g., parent fibers having an average diameter of greater than or equal to about 1 micron and less than or equal to about 25 microns). Other ranges are also possible.

In other embodiments, the parent fibers may have an average diameter in the nanometer range. For instance in, some embodiments, the parent fibers may have an average diameter of less than about 1 micron, less than or equal to about 0.8 microns, less than or equal to about 0.5 microns, less than or equal to about 0.1 microns, less than or equal to about 0.05 microns, less than or equal to about 0.02 microns, less than or equal to about 0.01 microns, or less than or equal to about 0.005 microns. In some embodiments, the parent fibers may have an average diameter of greater than or equal to about 0.003 microns, greater than or equal to about 0.004 micron, greater than or equal to about 0.01 microns, greater than or equal to about 0.05 microns, greater than or equal to about 0.1 microns, or greater than or equal to about 0.5 microns. Combinations of the above referenced ranges are also possible (e.g., parent fibers having an average diameter of greater than or equal to about 0.004 microns and less than about or equal to about 0.02 microns). Other ranges are also possible.

The average diameter of the fibrils is generally less than the average diameter of the parent fibers. Depending on the average diameter of the parent fibers, in some embodiments, the fibrils may have an average diameter of less than or equal to about 25 microns, less than or equal to about 20 microns, less than or equal to about 10 microns, less than or equal to about 5 microns, less than or equal to about 1 micron, less than or equal to about 0.5 microns, less than or equal to about 0.1 microns, less than or equal to about 0.05 microns, or less than or equal to about 0.01 microns. In some embodiments the fibrils may have an average diameter of greater than or equal to about 0.003 microns, greater than or equal to about 0.01 micron, greater than or equal to about 0.05 microns, greater than or equal to about 0.1 microns, greater than or equal to about 0.5 microns greater than or equal to about 1 micron, greater than or equal to about 5 microns, greater than or equal to about 10 microns, or greater than or equal to about 20 microns. Combinations of the above referenced ranges are also possible (e.g., fibrils having an average diameter of greater than or equal to about 0.01 microns and less than or equal to about 20 microns). Other ranges are also possible.

The level of fibrillation may be measured according to any number of suitable methods. For example, the level of fibrillation of the fibrillated fibers can be measured according to a Canadian Standard Freeness (CSF) test, specified by TAPPI test method T 227 om 09 (2009) Freeness of pulp. The test can provide an average CSF value.

In some embodiments, the average CSF value of the fibrillated fibers used in one or more layers may vary between about 5 mL and about 750 mL. In certain embodiments, the average CSF value of the fibrillated fibers used one or more layers may be greater than or equal to 1 mL, greater than or equal to about 10 mL, greater than or equal to about 20 mL, greater than or equal to about 35 mL, greater than or equal to about 45 mL, greater than or equal to about 50 mL, greater than or equal to about 65 mL, greater than or equal to about 70 mL, greater than or equal to about 75 mL, greater than or equal to about 80 mL, greater than or equal to about 100 mL, greater than or equal to about 150 mL, greater than or equal to about 175 mL, greater than or equal to about 200 mL, greater than or equal to about 250 mL, greater than or equal to about 300 mL, greater than or equal to about 350 mL, greater than or equal to about 500 mL, greater than or equal to about 600 mL, greater than or equal to about 650 mL, greater than or equal to about 700 mL, or greater than or equal to about 750 mL.

In some embodiments, the average CSF value of the fibrillated fibers used in one or more layers may be less than or equal to about 800 mL, less than or equal to about 750 mL, less than or equal to about 700 mL, less than or equal to about 650 mL, less than or equal to about 600 mL, less than or equal to about 550 mL, less than or equal to about 500 mL, less than or equal to about 450 mL, less than or equal to about 400 mL, less than or equal to about 350 mL, less than or equal to about 300 mL, less than or equal to about 250 mL, less than or equal to about 225 mL, less than or equal to about 200 mL, less than or equal to about 150 mL, less than or equal to about 100 mL, less than or equal to about 90 mL, less than or equal to about 85 mL, less than or equal to about 70 mL, less than or equal to about 50 mL, less than or equal to about 40 mL, less than or equal to about 25 mL, less than or equal to about 10 mL, or less than or equal to about 5 mL. Combinations of the above-referenced ranges are also possible (e.g., greater than or equal to about 10 mL and less than or equal to about 300 mL). Other ranges are also possible. The average CSF value of the fibrillated fibers used in one or more layers may be based on one type of fibrillated fiber or more than one type of fibrillated fiber.

In some embodiments, one or more layers (e.g., layer including fine polymeric staple fibers, second layer) and/or the entire filter media is substantially free of glass fibers (e.g., less than 1 wt % glass fibers, between about 0 wt % and about 1 wt % glass fibers). For instance, the layer including fine polymeric staple fibers, second layer, and/or the entire filter media may include 0 wt % glass fibers. Filter media and arrangements that are substantially free of glass fibers may be advantageous for certain applications (e.g., fuel-water separation, particulate separation in fuel systems), since glass fibers may shed and leach sodium ions (e.g., Na⁺) which can lead to physical abrasion and soap formation. For example, shedding of glass fibers may lead to the blockage of fuel injectors such as in high pressure common rail applications. In other embodiments, the second layer may optionally include glass fibers (e.g., microglass and/or chopped glass fibers).

In other embodiments, however, one or more layers and/or the entire filter media in the filter media may include glass fibers (e.g., microglass fibers, chopped strand glass fibers, or a combination thereof). The average diameter of glass fibers may be, for example, less than or equal to about 30 microns, less than or equal to about 25 microns, less than or equal to about 15 microns, less than or equal to about 12 microns, less than or equal to about 10 microns, less than or equal to about 9 microns, less than or equal to about 7 microns, less than or equal to about 5 microns, less than or equal to about 3 microns, or less than or equal to about 1 micron. In some instances, the glass fibers may have an average fiber diameter of greater than or equal to about 0.1 microns, greater than or equal to about 0.3 microns, greater than or equal to about 1 micron, greater than or equal to about 3 microns, or greater than equal to about 7 microns greater than or equal to about 9 microns, greater than or equal to about 11 microns, or greater than or equal to about 20 microns. Combinations of the above-referenced ranges are also possible (e.g., greater than or equal to about 0.1 microns and less than or equal to about 9 microns). Other values of average fiber diameter are also possible.

In some embodiments, the weight percentage of the glass fibers may be greater than or equal to about 0 wt %, greater than or equal to about 2 wt %, greater than or equal to about 5 wt %, greater than or equal to about 10 wt %, or greater than or equal to about 15 wt %. In some instances, the weight percentage of the glass fibers in the layer may be less than or equal to about 26 wt %, less than or equal to about 20 wt %, less than or equal to about 15 wt %, less than or equal to about 10 wt %, less than or equal to about 5 wt %, less than or equal to about 2 wt %, or less than or equal to about 1 wt %. Combinations of the above-referenced ranges are also possible (e.g., greater than or equal to about 0 wt % and less than or equal to about 10 wt %). Other values of weight percentage of the glass in a layer are also possible. In some embodiments, a layer or the filter media includes the above-noted ranges of glass fibers with respect to the total weight of fibers in the layer or filter media, respectively. In some embodiments, the above weight percentages are based on the weight of the total dry solids of the layer (including any resins).

In some embodiments, one or more layers and/or the entire filter media, in addition to a plurality of fibers, may also include other components, such as a resin, surface treatments, and/or additives. In general, any suitable resin may be used to achieve the desired properties. For example, the resin may be polymeric, water-based, solvent-based, dry strength, and/or wet strength. In certain embodiments, the resin may also include additives, such as flame retardants, hydrophobic additives, hydrophilic additives, viscose, nanoparticles, zeolite, natural polymers (starches, gums), cellulose derivatives, such as carboxymethyl cellulose, methylcellulose, hemicelluloses, synthetic polymers such as phenolics, latexes, polyamides, polyacrylamides, urea-formaldehyde, melamine-formaldehyde, polyamides), carbon fibers, particles, activated carbon, vermiculate, perlite, silicone, surfactants, coupling agents, crosslinking agents, conductive additives, viscosity modifiers, water repellants, a cross-linker, and/or pH adjuster, and/or diamaceous earth. It should be understood that the resin may, or may not, include other components. Typically, any additional components are present in limited amounts, e.g., less than 40% by weight of the resin, less than 20% by weight of the resin, less than 10% by weight of the resin, less than 5% by weight of the resin.

In some embodiments, at least a portion of the fibers of one or more layer (e.g., layer including fine polymeric staple fibers, second layer) may be coated with a resin without substantially blocking the pores of the fiber web. In some instances, substantially all of the fibers may be coated without substantially blocking the pores.

In some embodiments, the resin may be a binder resin. The binder resin is not in fiber form and is to be distinguished from binder fiber (e.g., multi-component fiber) described above. In general, the binder resin may have any suitable composition. For example, the binder resin may comprise a thermoplastic (e.g., acrylic, polyvinylacetate, polyester, polyamide), a thermoset (e.g., epoxy, phenolic resin), or a combination thereof. In some cases, a binder resin includes one or more of a vinyl acetate resin, an epoxy resin, a polyester resin, a copolyester resin, a polyvinyl alcohol resin, an acrylic resin such as a styrene acrylic resin, and a phenolic resin. Other resins are also possible.

As described further below, the resin may be added to the fibers in any suitable manner including, for example, in the wet state. In some embodiments, the resin coats the fibers and is used to adhere fibers to each other to facilitate adhesion between the fibers. Any suitable method and equipment may be used to coat the fibers, for example, using curtain coating, gravure coating, melt coating, dip coating, knife roll coating, or spin coating, amongst others. In some embodiments, the binder is precipitated when added to the fiber blend. When appropriate, any suitable precipitating agent (e.g., Epichlorohydrin, fluorocarbon) may be provided to the fibers, for example, by injection into the blend. In some embodiments, upon addition to the fibers, the resin is added in a manner such that one or more layer or the entire filter media is impregnated with the resin (e.g., the resin permeates throughout). In a multi-layered web, a resin may be added to each of the layers separately prior to combining the layers, or the resin may be added to the layer after combining the layers. In some embodiments, resin is added to the fibers while in a dry state, for example, by spraying or saturation impregnation, or any of the above methods. In other embodiments, a resin is added to a wet layer.

As noted above, in some embodiments, a filter media described herein may comprise one or more modified layers. In general, any suitable method for modifying the surface and/or the interior of a layer may be used. In some embodiments, the surface and/or interior of a layer may be modified by coating at least a portion of the surface and/or interior. In certain embodiments, a coating process involves introducing resin or a material (e.g., hydrophobic material, hydrophilic material) dispersed in a solvent or solvent mixture into a pre-formed fiber layer (e.g., a pre-formed fiber web formed by a wetlaid process, meltblown process, etc.). Non-limiting examples of coating methods include the use of vapor deposition (e.g., chemical vapor, physical vapor deposition), layer-by-layer deposition, wax-solidification, self-assembly, sol-gel processing, a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating (e.g., electrospraying), gapped roll coating, roll transfer coating, padding saturant coating, and saturation impregnation. Other coating methods are also possible. In some embodiments, the hydrophilic or hydrophobic material may be applied to the fiber web using a non-compressive coating technique. The non-compressive coating technique may coat the fiber web, while not substantially decreasing the thickness of the web. In other embodiments, the resin may be applied to the fiber web using a compressive coating technique.

In one set of embodiments, a surface and/or interior of a layer described herein is modified using chemical vapor deposition, e.g., at least a portion of a surface of a layer, interior of a layer, and/or an entire layer may comprise a chemical vapor deposition coating. In chemical vapor deposition, the fiber web is exposed to gaseous reactants from gas or liquid vapor that are deposited onto the fiber web under high energy level excitation such as thermal, microwave, UV, electron beam or plasma. Optionally, a carrier gas such as oxygen, helium, argon and/or nitrogen may be used.

Other vapor deposition methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI) and chemical beam epitaxy (CBE).

In physical vapor deposition (PVD) thin films are deposited by the condensation of a vaporized form of the desired film material onto substrate. This method involves physical processes such as high-temperature vacuum evaporation with subsequent condensation, or plasma sputter bombardment rather than a chemical reaction.

After applying the coating to the fiber web, the coating may be dried by any suitable method. Non-limiting examples of drying methods include the use of a photo dryer, infrared dryer, hot air oven steam-heated cylinder, or any suitable type of dryer familiar to those of ordinary skill in the art.

In some embodiments, at least a portion of the fibers of a layer (e.g., modified) may be coated without substantially blocking the pores of the fiber web. In some instances, substantially all of the fibers may be coated without substantially blocking the pores. In some embodiments, the fiber web may be coated with a relatively high weight percentage of resin or material without blocking the pores of a layer (e.g., modified) using the methods described herein (e.g., by dissolving and/or suspending one or more material in a solvent to form the resin).

In general, any suitable material may be used to alter the chemistry (e.g., surface chemistry), and accordingly the wettability, of a layer (e.g., modified). In some embodiments, the material may be charged. In some such embodiments, the charge (e.g., surface charge) of a layer (e.g., modified) may further facilitate coalescence and/or increase the water separation efficiency. For instance, in certain embodiments, a layer having a charged, hydrophilic modified surface may have greater fuel-water separation efficiency and/or produce larger coalesced droplets than a layer having an uncharged hydrophilic modified surface or a non-modified surface. In other embodiments, the charge (e.g., surface) of a layer (e.g., modified) renders the surface hydrophilic, but may not otherwise facilitate coalescence and/or increase the water separation efficiency.

In general, the net charge of the modified portion of a layer (e.g., surface, interior, entire layer) may be negative, positive, or neutral. In some instances, the modified layer (e.g., surface of the layer) may comprise a negatively charged material and/or a positively charged material. In some embodiments, the layer (e.g., surface of the layer) may be modified with an electrostatically neutral material. Non-limiting examples of materials that may be used to modify the layer include polyelectrolytes (e.g., anionic, cationic), oligomers, polymers (e.g., perfluoroalkyl ethyl methacrylate, polycaprolactone, poly [bis(trifluoroethoxy)phosphazene], polymers having carboxylic acid moieties, polymers having amine moieties, polyol), small molecules (e.g., carboxylate containing monomers, polymers having amine containing monomers, polyol), ionic liquids, monomer precursors, metals (e.g., gold, copper, tin, zinc, silicon, indium, tungsten), and gases, and combinations thereof.

In some embodiments, anionic polyelectrolytes may be used to modify the surface and/or interior of a layer (e.g., modified). For example, one or more anionic polyelectrolytes may be spray or dip coated onto at least one surface and/or interior of a layer (e.g., modified). Non-limiting examples of anionic polyelectrolytes that may be used to modify a surface include poly(2-acrylamido-2-methyl-1-propanesulfonic acid), poly(2-acrylamido-2-methyl-1-propanesulfonic acid-co-acrylonitrile), poly(acrylic acid), polyanetholesulfonic, poly(sodium 4-styrenesulfonate), poly(4-styrenesulfonic acid), poly(4-styrenesulfonic acid), poly(4-styrenesulfonic acid-co-maleic acid), poly(vinyl sulfate), and poly(vinylsulfonic acid, sodium), and combinations thereof.

In some embodiments, cationic polyelectrolytes may be used to modify the surface and/or interior of a layer (e.g., modified). Non-limiting examples of cationic polyelectrolytes that may be used to modify a surface and/or interior of a layer include polydiallyldimethylammonium chloride (PDDA), polyallyamine hydrochloride, poly(acrylamide-co-dimethylaminoethylacrylate-methyl), poly(acrylamide-co-diallyldimethylammonium), poly(4-vinyl pyridine), and amphiphilic polyelectrolytes of ionene type with ionized backbones, and combinations thereof.

In other embodiments, a modified layer may include a non-charged material used to modify the surface and/or interior of the layer.

In some embodiments, small molecules (e.g., monomers, polyol) may be used to modify at least one surface and/or interior of a layer. For example, polyols (e.g., glycerin, pentaerythritol, ethylene glycol, propylene glycol, sucrose), monobasic carboxylic acids, unsaturated dicarboxylic acids, and/or small molecules containing one or more amine may be used to modify at least one surface of a layer. In certain embodiments, small molecules may be deposited on at least one surface of a layer (e.g., modified) via coating (e.g., chemical vapor deposition). Regardless of the modification method, the small molecules on a surface and/or interior of a layer (e.g., modified) may be polymerized after deposition in some embodiments.

In certain embodiments, the small molecules, such as monobasic carboxylic acids and/or unsaturated dicarboxylic (dibasic) acids, may be used to modify at least one surface of a layer. For example, in some instances, monobasic carboxylic acids and/or unsaturated dicarboxylic (dibasic) acids may be polymerized after deposition using in-line ultraviolet polymerization. Non-limiting example of monobasic carboxylic acids that may be used to modify at least one surface of a layer include acrylic acid, methacrylic acid, crotonic acid, angelic acid, cytronellic acid, ricin acid, palmitooleic acid, erucic acid, 4-vinylbenzoic acid, sorbic acid, geranic acid, linolenic acid, and dehydrogeranic acid, and combinations thereof. Non-limiting example of unsaturated dicarboxylic (dibasic) acids that may be used to modify at least one surface of a layer include maleic acid, itaconic acid, acetylendicarboxylic acid, and maleic acid monoamide acid, and combinations thereof.

In certain embodiments, the small molecules may be amine containing small molecules. The amine containing small molecules may be primary, secondary, or tertiary amines. In some such cases, the amine containing small molecule may be a monomer. Non-limiting examples of amine containing small molecules (e.g., amine containing monomers) that may be used to modify at least one surface of a layer (e.g., modified) include allylamine, 2-aminophenyl disulfide, 4-aminophenyl propargyl ether, 1,2,4,5-benzenetetracarboxamide, 1,2,4,5-benzenetetramine, 4,4′-(1,1′-biphenyl-4,4′-diyldioxy)dianiline, 2,2-bis(aminoethoxy)propane, 6-chloro-3,5-diamino-2-pyrazinecarboxamide, 4-chloro-o-phenylenediamine, 1,3-cyclohexanebis(methylamine), 1,3-diaminoacetone, 1,4-diaminoanthraquinone, 4,4′-diaminobenzanilide, 3,4-diaminobenzophenone, 4,4′-diaminobenzophenone, 2,6-diamino-4-chloropyrimidine 1-oxide, 1,5-diamino-2-methylpentane, 1,9-diaminononane, 4,4′-diaminooctafluorobiphenyl, 2,6-diaminopurine, 2,4-diaminotoluene, 2,6-diaminotoluene, 2,5-dichloro-p-phenylenediamine, 2,5-dimethyl-1,4-phenylenediamine, 2-dimethyl-1,3-propanediamine, 4,9-dioxa-1,12-dodecanediamine, 1,3-diaminopentane, 2,2′-(ethylenedioxy)bis(ethylamine), 4,4′-(hexafluoroisopropylidene)bis(p-phenyleneoxy)dianiline, 4,4′-(hexafluoroisopropylidene)dianiline, 5,5′-(hexafluoroisopropylidene)di-o-toluidine, 4,4′-(4,4′-isopropylidenediphenyl-1,1′-diyldioxy)dianiline, 4,4′-methylene-bis(2-chloroaniline), 4,4′-methylenebis(cyclohexylamine), 4,4′-methylenebis(2,6-diethylaniline), 4,4′-methylenebis(2,6-dimethylaniline), 3,3′-methylenedianiline, 3,4′-oxydianiline, 4,4′-(1,3-phenylenediisopropylidene)bisaniline, 4,4′-(1,4-phenylenediisopropylidene)bisaniline, 4,4′-(1,3-phenylenedioxy)dianiline, (1,4-butanediol)bis(4-aminobenzoate) oligomer, 2,3,5,6-tetramethyl-p-phenylenediamine, 2,4,6-trimethyl-m-phenylenediamine, 4,7,10-trioxa-1,13-tridecanediamine, tris(2-aminoethyl)amine, p-xylylenediamine, cyclen, N,N′-diethyl-2-butene-1,4-diamine, N,N′-diisopropylethylenediamine, N,N′-diisopropyl-1,3-propanediamine, N,N′-dimethyl-1,3-propanediamine, N,N′-diphenyl-p-phenylenediamine, 2-(penta-4-ynyl)-2-oxazoline, 1, 4,8,12-tetraazacyclopentadecane, 1,4,8,11-tetraazacyclotetradecane-5,7-dione, 1-[bis[3-(dimethylamino)propyl]amino]-2-propanol, 1,4-diazabicyclo[2.2.2]octane, 1,6-diaminohexane-N,N,N′,N′-tetraacetic acid, 2-[2-(dimethylamino)ethoxy]ethanol, N,N,N′,N″,N″-pentamethyldiethylenetriamine, N,N,N′,N′-tetraethyl-1,3-propanediamine, N,N,N′,N′-tetramethyl-1,4-butanediamine, N,N,N′,N′-tetramethyl-2-butene-1,4-diamine, N,N,N′,N′-tetramethyl-1,6-hexanediamine, 1,4,8,11-Tetramethyl-1,4,8,11-tetraazacyclotetradecane, and 1,3,5-Trimethylhexahydro-1,3,5-triazine, and combinations thereof. In certain embodiments, an amine containing monomer may be a derivative of one or more of the above-referenced amine containing small molecules (e.g., acrylamide) that has one or more functional groups (e.g., unsaturated carbon-carbon bond) capable of reacting with other molecules to form a polymer.

In some embodiments, the small molecule may be an inorganic or organic hydrophobic molecule. Non-limiting examples include hydrocarbons (e.g., CH₄, C₂H₂, C₂H₄, C₆H₆), fluorocarbons (e.g., CF₄, C₂F₄, C₃F₆, C₃F₈, C₄H₈, C₅H₁₂, C₆F₆), silanes (e.g., SiH₄, Si₂H₆, Si₃H₈, Si₄H₁₀), organosilanes (e.g., methylsilane, dimethylsilane, triethylsilane), siloxanes (e.g., dimethylsiloxane, hexamethyldisiloxane), ZnS, CuSe, InS, CdS, tungsten, silicon carbide, silicon nitride, silicon oxynitride, titanium nitride, carbon, silicon-germanium, and hydrophobic acrylic monomers terminating with alkyl groups and their halogenated derivatives (e.g., ethyl 2-ethylacrylate, methyl methacrylate; acrylonitrile). In certain embodiments, suitable hydrocarbons for modifying a surface of a layer may have the formula CₓH_{y}, where x is an integer from 1 to 10 and y is an integer from 2 to 22. In certain embodiments, suitable silanes for modifying a surface of a layer may have the formula SiₙH₂ₙ₊₂ where any hydrogen may be substituted for a halogen (e.g., Cl, F, Br, I), and where n is an integer from 1 to 10.

As used herein, “small molecules” refers to molecules, whether naturally-occurring or artificially created (e.g., via chemical synthesis) that have a relatively low molecular weight. Typically, a small molecule is an organic compound (i.e., it contains carbon). The small organic molecule may contain multiple carbon-carbon bonds, stereocenters, and other functional groups (e.g., amines, hydroxyl, carbonyls, and heterocyclic rings, etc.). In certain embodiments, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain embodiments, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

In some embodiments, polymers may be used to modify at least one surface and/or interior of a layer. For example, one or more polymers may be applied to at least a portion of a surface and/or interior of a layer via a coating technique. In certain embodiments, the polymer may be formed from monobasic carboxylic acids and/or unsaturated dicarboxylic (dibasic) acids. In certain embodiments, the polymer may be a graft copolymer and may be formed by grafting polymers or oligomers to polymers in the fibers and/or fiber web (e.g., resin polymer). The graft polymer or oligomer may comprise carboxyl moieties that can be used to form a chemical bond between the graft and polymers in the fibers and/or fiber web. Non-limiting examples of polymers in the fibers and/or fiber web that can be used to form a graft copolymer include polyethylene, polypropylene, polycarbonate, polyvinyl chloride, polytetrafluoroethylene, polystyrene, cellulose, polyethylene terephthalate, polybutylene terephthalate, and nylon, and combinations thereof. Graft polymerization can be initiated through chemical and/or radiochemical (e.g., electron beam, plasma, corona discharge, UV-irradiation) methods. In some embodiments, the polymer may be a polymer having a repeat unit that comprises an amine (e.g., polyallylamine, polyethyleneimine, polyoxazoline). In certain embodiments, the polymer may be a polyol.

In some embodiments, a gas may be used to modify at least one surface and/or interior of a layer (e.g., modified). In some such cases, the molecules in the gas may react with material (e.g., fibers, resin, additives) on the surface of a layer (e.g., modified) to form functional groups, such as charged moieties, and/or to increase the oxygen content on the surface of the layer. Non-limiting examples of functional groups include hydroxyl, carbonyl, ether, ketone, aldehyde, acid, amide, acetate, phosphate, sulfite, sulfate, amine, nitrile, and nitro groups. Non-limiting examples of gases that may be reacted with at least one surface of a layer (e.g., modified) includes CO₂, SO₂, SO₃, NH₃, N₂H₄, N₂, H₂, He, Ar, and air, and combinations thereof.

Fiber media described herein may be used in an overall filtration arrangement or filter element. In some embodiments, one or more additional layers or components are included with the filter media (e.g., disposed adjacent to the layer including fine polymeric staple fibers or the second layer). Non-limiting examples of additional layers (e.g., a third layer, a fourth layer) include a meltblown layer, a wet laid layer, a spunbond layer, a carded layer, an air-laid layer, a spunlace layer, a forcespun layer, a centrifugal spun layer or an electrospun layer. In some embodiments, multiple fine polymeric staple fiber layers, in accordance with embodiments described herein, may be layered together in forming a multi-layer sheet for use in a filter media or element.

As described herein, in some embodiments two or more layers of the filter media (e.g., layer including fine polymeric staple fibers and the second layer) may be formed separately, and combined by any suitable method such as lamination, collation, or by use of adhesives. The two or more layers may be formed using different processes, or the same process. For example, each of the layers may be independently formed by a wet laid process, a non-wet laid process (e.g., meltblown process, melt spinning process, centrifugal spinning process, electrospinning process, dry laid process, air laid process), or any other suitable process.

In some embodiments, two or more layers (e.g., layer including fine polymeric staple fibers and the second layer) may be formed by the same process. In some instances, the two or more layers (e.g., layer including fine polymeric staple fiber and the second layer) may be formed simultaneously.

Different layers may be adhered together by any suitable method. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

The filter media may include any suitable number of layers, e.g., at least 2, at least 3, at least 4, at least 5, at least 6, at least 7 layers. In some embodiments, the filter media may include up to 20 layers.

In certain embodiments, the filter media may include a gradient in one or more properties through portions of the thickness of the filter media. For instance, the filter media may include a gradient in hydrophobicity or hydrophilicity. Such a gradient may aid in fluid separation (e.g., fuel:water separation). In the portions of the filter media where the gradient in the property is not present, the property may be substantially constant through that portion of the web. As described herein, in some instances a gradient in a property involves different proportions of a component (e.g., a type of fiber such as a fine polymeric staple fiber and/or a fibrillated fiber, a material used for modifying the surface of a layer, an additive, a binder) across the thickness of the filter media. In some embodiments, a component may be present at an amount or a concentration that is different than another portion of the filter media. In other embodiments, a component is present in one portion of the filter media, but is absent in another portion of the filter media. Other configurations are also possible.

In some embodiments, a filter media has a gradient in one or more properties in two or more regions of the filter media. For example, a filter media including two layers may have a first gradient in one property across the first layer, and a second gradient in another property across the second layer. The first and second gradients may be the same in some embodiments, or different in other embodiments (e.g., characterized by a gradual vs. an abrupt change in a property across the thickness of the filter media). Other configurations are also possible.

Filter media described herein may be produced using suitable processes, such as using a wet laid or a non-wet laid process. In general, a wet laid process involves mixing together of fibers of one or more type; for example, fine polymeric staple fibers of one type may be mixed together with fine polymeric staple fibers of another type, and/or with fibers of a different type (e.g., synthetic fibers and/or glass fibers), to provide a fiber slurry. The slurry may be, for example, an aqueous-based slurry. In certain embodiments, fibers, are optionally stored separately, or in combination, in various holding tanks prior to being mixed together (e.g., to achieve a greater degree of uniformity in the mixture).

For instance, a first fiber may be mixed and pulped together in one container and a second fiber may be mixed and pulped in a separate container. The first fibers and the second fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In certain embodiments, a media including two or more layers, such as a layer including fine polymeric staple fibers and a second layer, is formed by a wet laid process. For example, a first dispersion (e.g., a pulp) containing fibers in a solvent (e.g., an aqueous solvent such as water) can be applied onto a wire conveyor in a papermaking machine (e.g., a fourdrinier or a rotoformer) to form first layer supported by the wire conveyor. A second dispersion (e.g., another pulp) containing fibers in a solvent (e.g., an aqueous solvent such as water) is applied onto the first layer either at the same time or subsequent to deposition of the first layer on the wire. Vacuum is continuously applied to the first and second dispersions of fibers during the above process to remove the solvent from the fibers, thereby resulting in an article containing first and second layers. The article thus formed is then dried and, if necessary, further processed (e.g., calendered) by using known methods to form multi-layered filter media. In some embodiments, such a process may result in a gradient in at least one property across the thickness of the two or more layers.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

Wet laid processes may be particularly suitable for forming gradients of one or more properties in a filter media, such as those described herein. For instance, in some cases, the same slurry is pumped into separate headboxes to form different layers and/or a gradient in a filter media. In other cases, two or more different slurries may be pumped into separate headboxes to form different layers and/or a gradient in a filter media. In other embodiments, a first layer can be formed and a second layer can be formed on top, drained, and dried.

In some cases, the pH of the fiber slurry may be adjusted as desired. For instance, fibers of the slurry may be dispersed under generally neutral conditions. Before the slurry is sent to a headbox, the slurry may optionally be passed through centrifugal cleaners and/or pressure screens for removing unfiberized material. The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, a cylinder, or an inclined wire fourdrinier. In some processes, the wet laid layer can be formed on a non-wet laid layer (e.g., scrim).

As described herein, in some embodiments, a resin is added to a layer (e.g., a pre-formed layer formed by a wet-laid process). For instance, as the layer is passed along an appropriate screen or wire, different components included in the resin (e.g., polymeric binder, an acid scavenger, and/or other components), which may be in the form of separate emulsions, are added to the fiber layer using a suitable technique. In some cases, each component of the resin is mixed as an emulsion prior to being combined with the other components and/or layer. The components included in the resin may be pulled through the layer using, for example, gravity and/or vacuum. In some embodiments, one or more of the components included in the resin may be diluted with softened water and pumped into the layer. In some embodiments, a resin may be applied to a fiber slurry prior to introducing the slurry into a headbox. For example, the resin may be introduced (e.g., injected) into the fiber slurry and impregnated with and/or precipitated on to the fibers. In some embodiments, a resin may be added to a layer by a solvent saturation process.

In other embodiments, a non-wet laid process (e.g., a dry laid process, an air laid process, a spinning process such as electrospinning or centrifugal spinning, a meltblown process) is used to form all or portions of a filter media (e.g., the second layer). For example, in an air laid process, in some embodiments, synthetic fibers may be blown via air onto a conveyor, and a resin is then applied. In a carding process, in some embodiments, the fibers are manipulated by rollers and extensions (e.g., hooks, needles) associated with the rollers prior to application of the binder. In some cases, forming the layers through a non-wet laid process may be more suitable for the production of a highly porous media. The dry layer may be impregnated (e.g., via saturation, spraying, etc.) with any suitable resin, as discussed above.

In certain embodiments, a layer (e.g., second layer) may be formed by a meltblowing system, such as the meltblown system described in U.S. Publication No. 2009/0120048, filed Nov. 7, 2008, and entitled “Meltblown Filter Medium”, and U.S. Publication No. 2012-0152824, filed Dec. 17, 2010, and entitled, “Fine Fiber Filter Media and Processes”, each of which is incorporated herein by reference in its entirety for all purposes. In certain embodiments, a layer (e.g., second layer) may be formed by a meltspinning or a centrifugal spinning process. In some embodiments, a non-wet laid process, such as an air laid or carding process may be used to form a layer (e.g., second layer). For example, in an air laid process, synthetic fibers may be mixed, while air is blown onto a conveyor. In a carding process, in some embodiments, the fibers are manipulated by rollers and extensions (e.g., hooks, needles) associated with the rollers. In some cases, forming the layers through a non-wet laid process may be more suitable for the production of a highly porous media. The layer may be impregnated (e.g., via saturation, spraying, etc.) with any suitable resin, as discussed above. In some embodiments, a non-wet laid process (e.g., meltblown, electrospun) may be used to form a layer (e.g., second layer) and a wet laid process may be used to form another layer (e.g., first layer). The layers may be combined using any suitable process (e.g., lamination, co-pleating, or collation).

During or after formation of a filter media, the filter media may be further processed according to a variety of known techniques. For instance, a coating method may be used to include a resin in the filter media. Optionally, additional layers can be formed and/or added to a filter media using processes such as lamination, co-pleating, or collation. For example, in some cases, two layers (e.g., fine staple fiber layer and the second layer) are formed into a composite article by a wet laid process as described above, and the composite article is then combined with a third layer by any suitable process (e.g., lamination, co-pleating, or collation). It can be appreciated that a filter media or a composite article formed by the processes described herein may be suitably tailored not only based on the components of each layer, but also according to the effect of using multiple layers of varying properties in appropriate combination to form filter media having the characteristics described herein.

In some embodiments, further processing may involve pleating the filter media. For instance, two layers may be joined by a co-pleating process. In some cases, the filter media, or various layers thereof, may be suitably pleated by forming score lines at appropriately spaced distances apart from one another, allowing the filter media to be folded. In some cases, the filter media may be wrapped around each other around a core, or one layer can be wrapped around a pleated layer. It should be appreciated that any suitable pleating technique may be used. In some embodiments, a filter media can be post-processed such as subjected to a corrugation process to increase surface area within the web. In other embodiments, a filter media may be embossed.

It should be appreciated that the filter media may include other parts in addition to the one or more layers described herein. In some embodiments, further processing includes incorporation of one or more structural features and/or stiffening elements. For instance, the filter media may be combined with additional structural features such as polymeric and/or metallic meshes. In one embodiment, a screen backing may be disposed on the filter media, providing for further stiffness. In some cases, a screen backing may aid in retaining the pleated configuration. For example, a screen backing may be an expanded metal wire or an extruded plastic mesh.

In some embodiments, a layer described herein may be a non-woven web. A non-woven web may include non-oriented fibers (e.g., a random arrangement of fibers within the web). Examples of non-woven webs include webs made by wet-laid or non-wet laid processes as described herein. Non-woven webs also include papers such as cellulose-based webs.

In some embodiments, filter media can be incorporated into a variety of filter elements for use in various filtering applications. Exemplary types of filters include fuel filters (e.g., automotive fuel filters), hydraulic mobile filters, hydraulic industrial filters, oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media. The filter media may be suitable for filtering gases or liquids.

In some embodiments, the filter media layers may be pleated, wrapped with or without a core, wrapped around a pleated media in, e.g., a fuel water separator. In certain embodiments, a collection bowl or other suitable component may be positioned upstream, downstream, or both upstream and downstream of the media. A collection bowl is a vessel that is used to collect water after it is shed/separated/coalesced from the media. The collection bowl may be part of the filter element or filter housing.

The layer including fine polymeric staple fibers and/or the filter media disclosed herein can be incorporated into a variety of filter elements for use in various applications including hydraulic and non-hydraulic filtration applications including fuel applications, lube applications, air applications, amongst others.

Filter elements can also be in any suitable form, such as pleated filter, capsules, spiral wound elements, plate and frame devices, flat sheet modules, vessel bags, disc tube units, radial filter elements, panel filter elements, or channel flow elements. A radial filter element can include pleated filter media that are constrained within two open wire meshes in a cylindrical shape. During use, fluids can flow from the outside through the pleated media to the inside of the radial element.

### EXAMPLES

The following examples are intended to illustrate certain embodiments of the present invention, but are not to be construed as limiting and do not exemplify the full scope of the invention.

### Example 1

This example describes four dual layer filter media containing a first layer including 100 wt. % hydrophobic polyetherimide (PEI) staple fibers having an average diameter of less than or equal to about 1 micron, and a second layer. Filter media 1 and 2 included a second layer containing cellulose pulp fibers and polyester fibers and differed only in basis weight of the first layer. Filter media 3 and 4 included a second layer containing 100 wt. % synthetic fibers and differed only in basis weight of the first layer. The first layer was used to increase the particulate and/or fuel:water separation efficiency of the filter media without substantially increasing the thickness of the filter media, and without the use of glass fibers. The filter media had a relatively high fuel:water separation efficiency and/or particulate efficiency compared to a filter media comprising the same second layer as filter media 1-4 and a first, meltblown layer that contained 0 wt. % glass fibers.

The dual layer filter media were made using a laboratory handsheet mold. The fibers for the second layer were mixed in a blender with 1000 mL of water for 2 minutes. The slurry was placed in a handsheet mold and the fiber web was formed on a wire. The fiber web was drained and dried. Then the fiber web was placed back into the handsheet mold, and another slurry for forming the first layer was placed into the handsheet mold and formed on top of the second layer. The resulting fiber web was drained and dried. For filter media 1 and 2, the resulting fiber webs included a second layer comprising cellulose pulp and polyester fibers and a first layer comprising fine PEI staple fibers. For filter media 3 and 4, the resulting filter media included a second layer comprising 100% synthetic fibers and a first layer comprising fine PEI staple fibers.

For filter media 1 and 2, the amount of material added for the second layer was 10.91 g (Prince George pulp, Porosanier pulp, Suzano pulp, polyester (diameter of 7.16 microns, 3.125 mm length) and kuralon SPG-056 polyvinyl alcohol fiber in the ratio of [10:37:47:5:1]) and the amount of material (100% PEI staple fiber with diameter of less than 1 micron and length of approximately 1 mm) added for the first layer was 3.03 g. For filter media 3 and 4, the amount of material added for the second layer was 10.9 g of fibrillated acrylic pulp (Canadian standard freeness of 250 ml), polyester fiber (Teijin, 7.4 micron diameter, 5 mm length), polyester fiber (12.5 micron diameter, 5 mm length), polyester (diameter of 7.2 microns, 3.125 mm length), and kuralon SPG-056 polyvinyl alcohol fiber in the ratio of 26:21:36:16:1. The amount of material (100% PEI staple fiber with diameter of less than 1 micron and length of approximately 1 mm) added for the first layer was 3.03 g.

For all filter media, a scrim was laminated onto the surface of the first layer, which was the top layer, for support. The first layer of filter media 2 and 3 had a basis weight of 10 lb/ream (16 g/m²). The first layer of filter media 1 and 4 had a basis weight of 20 lb/ream (33 gsm). In all filter media, the second layer had a basis weight of 72 lb/ream (116 g/m²). For filter media 1 and 2, the scrim had a basis weight of 27 lb/ream (44 g/m²). For filter media 3 and 4, the scrim had a basis weight of 18 lb/ream (29 g/m²).

As a media used for comparison, a filter media including a first, meltblown layer having a basis weight of 20 lb/ream (33 gsm) and an average fiber diameter of about 3 microns laminated to a second layer formed as described above for filter media 1-4, was formed.

Multipass Filter Tests for determining efficiency and dust holding capacity were performed as described above. The average and initial fuel water separation efficiencies of the filter media were determined using the SAEJ1488 standard (2010). The standard test fluid was 15 dynes/cm.

Table 1 shows various structural properties of the filter media 1-4. For filter media 1 and 2, the second layer had a water contact angle of 110° and the fine PEI staple fiber layer had a water contact angle of 128°. For filter media 3 and 4, the second layer had a water contact angle of 115° and the fine PEI staple fiber layer had a water contact angle of 128°. Accordingly, in all the filter media, the first layer was more hydrophobic than the second layer.

TABLE 1
Properties of Filter Media Including Fine Polymeric Staple Fibers

| | | | | Initial | Ave. | | Initial | Avg. |
|---|---|---|---|---|---|---|---|---|
| | Basis | Air | | Particle | Particle | | separation | separation |
| Filter | Weight | Perm. | Caliper | Eff. | Eff. | DHC | efficiency | efficiency |
| Media | (lb/ream) | (cfm) | (mm) | (%) | (%) | (g/m²) | (%) | (%) |
| 1 | 119 | 6.38 | 0.62 | 96.47 | 98.76 | 156 | 61 | 60 |
| 2 | 110 | 9.34 | 0.60 | 86.50 | 95.28 | 135 | 61 | 60 |
| 3 | 100 | 12.3 | 0.63 | 78.02 | 86.85 | 104 | 67.1 | 60 |
| 4 | 110 | 9.7 | 0.69 | 93.20 | 94.94 | 104 | 69.7 | 65.4 |
| Meltblown | 119 | 14 | 0.85 | 54 | 53 | 163 | 59 | 43 |

This example shows that a glass-free filter media having a final particulate efficiency of greater than 95%, initial particulate efficiency of greater than 95%, and/or an average fuel:water separation efficiency of greater than or equal to 60% can be achieved by a dual layer media including a layer of fine staple fibers and a second layer. The relatively high water separation efficiencies at low interfacial tension conditions (15-19 dynes/cm) were achieved by adding a layer of fine staple fibers that had a greater hydrophobicity than the hydrophobicity of the second layer. Since droplet size is dependent on interfacial tension, low interfacial tension conditions (e.g., less than about 20 dynes/cm) result in droplets having a relatively small diameter that are relatively difficult to separate. This example shows that the dual layer media including fine polymeric staple fibers can achieve higher average and initial particle efficiencies, and comparable or higher average and initial water separation efficiencies, compared to meltblown media having a similar basis weight and thickness.

### Example 2

This example describes two dual layer filter media having a relatively high particulate efficiency that contained a first layer including cellulose acetate (CA) staple fibers having an average diameter of less than or equal to about 1 micron and less than the PEI fibers in Example 1, and a second layer comprising 100 wt. % synthetic fibers. Filter media 5 and 6 included a first layer containing cellulose acetate staple fibers and differed only in basis weight of the first layer.

Dual layer filter media were made using a laboratory handsheet mold. The fibers for the first layer were mixed in a blender with 1000 mL of water for 2 minutes. The slurry was placed in a handsheet mold and the fiber web was formed on a wire. The fiber web was drained and dried. Then the fiber web was placed back into the handsheet mold, and the second slurry was placed into the handsheet mold and formed on top of the first layer. The resulting fiber web was drained and dried. The resulting fiber webs included a second layer comprising all synthetic fiber blend and a first layer comprising CA staple fibers in two different top layer basis weights 16.28 gsm and 32.55 gsm. The amount of material added for the second layer was 10.9 g of fibrillated acrylic pulp (Canadian standard freeness of 250 ml), polyester fiber (Teijin, 7.4 micron diameter, 5 mm length), polyester fiber (12.5 micron diameter, 5 mm length), polyester (diameter of 7.2 microns, 3.125 mm length), and kuralon SPG-056 polyvinyl alcohol fiber in the ratio of 26:21:36:16:1. The total amount of material added for the first layer was 1.51 g and 3.03 g to make the 16.28 gsm (filter media 5) and 32.55 gsm (filter media 6) layer respectively. A scrim was laminated onto the surface of the first layer for support.

Efficiency and dust holding capacity tests were performed as described in Example 1. Table 2 shows various structural properties of the filter media 5-6.

TABLE 2
Properties of Filter Media Including Fine Polymeric Staple Fibers

| | | | | | | | Initial | Avg. |
|---|---|---|---|---|---|---|---|---|
| | Basis | Air | | Initial | Final | | separation | separation |
| Filter | Weight | Perm. | Caliper | Eff. | Eff. | DHC | efficiency | efficiency |
| Media | (lb/ream) | (cfm) | (mm) | (%) | (%) | (g/m²) | (%) | (%) |
| 5 | 138 | 3.0 | 0.60 | 99.97 | 99.98 | 166 | 50 | 35 |
| 6 | 158 | 1.47 | 0.64 | 99.73 | 99.95 | 129 | 51 | 43 |

This example shows that a glass-free filter media having a final particulate efficiency of greater than 99.9% can be achieved by a dual layer media including a layer of fine staple fibers and a second layer.

### Example 3

This example describes three dual layer filter media having a relatively high particulate efficiency that contained a first layer including a blend of hydrophilic and hydrophobic synthetic staple fibers having an average diameter of less than or equal to about 1 micron, and a second layer comprising 100 wt. % synthetic fibers. Filter media differed only in the ratio of cellulose acetate staple fibers to polyetherimide staple fibers used in the first layer. The cellulose acetate staple fibers had a smaller average diameter than the polyetherimide staple fibers.

Dual layer filter media were made using a laboratory handsheet mold. The fibers for the first layer were mixed in a blender with 1000 mL of water for 2 minutes. The slurry was placed in a handsheet mold and the fiber web was formed on a wire. The fiber web was drained and dried. Then the fiber web was placed back into the handsheet mold, and the second slurry was placed into the handsheet mold and formed on top of the first layer. The resulting fiber web was drained and dried. The resulting fiber webs included a second layer comprising all synthetic fiber blend and a first layer comprising PEI and CA staple fibers in different ratios such as 1:3, 1:1, and 3:1 (i.e., filter media 7, 8, and 9, respectively). The amount of material added for the second layer was 10.9 g of fibrillated acrylic pulp (Canadian standard freeness of 250 ml), polyester fiber (Teijin, 7.4 micron diameter, 5 mm length), polyester fiber (12.5 micron diameter, 5 mm length), polyester (diameter of 7.2 microns, 3.125 mm length), and kuralon SPG-056 polyvinyl alcohol fiber in the ratio of 26:21:36:16:1 The total amount of material (depending on ratio of PEI and cellulose acetate) added for the first layer was 3.03 g. A scrim was laminated onto the surface of the first layer for support.

Efficiency and dust holding capacity tests were performed as described in Example 1. Table 3 shows various structural properties of the filter media 7-9.

TABLE 3
Properties of Filter Media Including Fine Polymeric Staple Fibers

| | | | | | | | | Initial | Avg. |
|---|---|---|---|---|---|---|---|---|---|
| | Basis | Air | | Initial | Final | | Specific | separation | separation |
| Filter | Weight | Perm. | Caliper | Eff. | Eff. | DHC | DHC | efficiency | efficiency |
| Media | (lb/ream) | (cfm) | (mm) | (%) | (%) | (g/m²) | (g/m²/mm) | (%) | (%) |
| 7 (3:1) | 177 | 5.3 | 0.76 | 99.60 | 99.82 | 133 | 175 | 61 | 60 |
| 8 (1:3) | 177 | 2.8 | 0.79 | 99.82 | 99.86 | 112 | 142 | 61 | 60 |
| 9 (1:1) | 177 | 3.2 | 0.78 | 99.85 | 99.95 | 132 | 169 | 67.1 | 60 |

This example shows that a glass-free filter media having a final particulate efficiency of greater than 99.5%, initial particulate efficiency of greater than 99.55%, and an average fuel:water separation efficiency of greater than or equal to 60% for low interfacial tension fluids can be achieved by a dual layer media including a layer of fine staple fibers and a second layer.

### Example 4

This example describes the combination of the dual layer filter media with another filtration layer designed to further enhance dust holding capacity and fuel:water separation.

The filter media 9 in Example 3 was collated with 100 gsm polybutylene terephthalate (PBT) meltblown. Efficiency and dust holding capacity tests were performed as described in Example 1. Table 4 shows various structural properties of filter media 10.

TABLE 4
Properties of Filter Media Including Fine Polymeric
Staple Fibers and a Meltblown Layer

| | | | | | | | Initial | Avg. |
|---|---|---|---|---|---|---|---|---|
| | Basis | Air | | Initial | Final | | separation | separation |
| Filter | Weight | Perm. | Caliper | Eff. | Eff. | DHC | efficiency | efficiency |
| Media | (lb/ream) | (cfm) | (mm) | (%) | (%) | (g/m²) | (%) | (%) |
| 10 | 277 | 2.86 | 1.1 | 99.80 | 99.94 | 178 | 71 | 68 |

The meltblown layer further enhanced the dust holding capacity and fuel:water separation efficiency of the dual layer filter media.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media comprising:
a first layer comprising a first plurality of polymeric staple fibers having an average fiber diameter of less than or equal to about 3 microns and an average length of less than or equal to about 10 cm;
a second layer comprising fibers having an average fiber diameter of greater than or equal to about 4 microns; and
a third layer, wherein the third layer is a non-wetlaid layer,
wherein at least one surface of the first, second, and third layers is surface modified, and
wherein the filter media has an air permeability between 0.3 CFM and 300 CFM and a basis weight of between 5 g/m² and 1,000 g/m².

2. A filter media comprising:
a modified layer comprising a first plurality of polymeric staple fibers having an average fiber diameter of less than or equal to about 1 micron and an average length of less than or equal to about 10 cm, wherein the thickness of the first layer is less than or equal to about 0.2 mm; and
a second layer comprising fibers having an average fiber diameter of greater than or equal to about 4 microns, wherein the filter media has a dry Mullen burst strength between 0.5 psi and 200 psi.

3. A filter media comprising:
a modified layer comprising a first plurality of polymeric staple fibers having an average diameter of less than or equal to about 1 micron and a second plurality of polymeric staple fibers having an average diameter of less than or equal to 1 micron, wherein the first layer has a water contact angle between about 30 degrees and 165 degrees; and
a second layer comprising fibers having an average diameter of greater than or equal to about 4 microns, wherein the filter media has an air permeability between 0.3 CFM and 300 CFM and a basis weight of between 5 g/m² and 1,000 g/m².

4. A filter media comprising:
a first layer comprising first plurality of polymeric staple fibers having an average fiber diameter of less than or equal to about 1 micron and an average length of less than or equal to about 10 cm;
a second non-wet laid layer comprising fibers having an average fiber diameter of greater than or equal to about 4 microns; and
a mesh layer.

5. A filter media as in claim 1, wherein the first layer has a thickness of less than or equal to about 0.2 mm.

6. A filter media as in claim 1, wherein the first layer comprises greater than or equal to about 50 wt. % of the first plurality of polymeric staple fibers.

7. A filter media as in claim 1, wherein the water contact angle of the first layer is greater than or equal to about 35 degrees and less than or equal to about 165 degrees.

8. A filter media as in claim 1, wherein the water contact angle of the first layer is greater than or equal to about 90 degrees.

9. A filter media as in claim 1, wherein the water contact angle of the second layer is less than about 90 degrees.

10. A filter media as in claim 1, wherein the first plurality of polymeric staple fibers have an average diameter of less than or equal to about 0.5 microns.

11. A filter media as in claim 1, wherein the fibers of the second layer have an average diameter of greater than or equal to about 5 microns and less than or equal to about 15 microns.

12. A filter media as in claim 1, wherein the first layer has a basis weight of greater than or equal to about 5 g/m² and less than or equal to about 100 g/m².

13. A filter media as in claim 1, wherein the second layer comprises continuous fibers.

14. A filter media as in claim 1, wherein the second layer comprises synthetic fibers.

15-22. (canceled)

23. A filter media as in claim 1, wherein the filter media comprises between about 0 wt % and about 1 wt % glass fibers.

24. A filter element comprising the filter media of claim 1.

25. A filter media as in claim 1, wherein the first layer comprises a second plurality of polymeric staple fibers.

26. A filter media as in claim 1, wherein the first plurality of polymeric staple fibers have an average diameter of less than or equal to about 0.5 microns.

27. A filter media as in claim 1, wherein the first plurality of polymeric staple fibers are formed of a material that is more hydrophobic than a material used to form the second plurality of polymeric staple fibers.

28. A filter media as in claim 1, wherein the first plurality of polymeric staple fibers are formed of a material that is more hydrophilic than a material used to form the second plurality of polymeric staple fibers.

29. (canceled)

30. A filter media as in claim 1, wherein the first plurality of polymeric staple fibers of the first layer are formed of a material having a greater hydrophobicity than a hydrophobicity of the second layer.

31. (canceled)

32. A filter media as in claim 1, wherein the third layer is a meltblown layer.

33. A filter media as in claim 1, wherein the third layer is a non-fibrous layer.

34. A filter media as in claim 1, wherein the third layer is a mesh.
